(19) United States
(12) Patent Application Publication
(10) Pub. No.: US 2011/0213631 A1
(43) Pub. Date: Sep. 1, 2011

(54) SYSTEM AND METHOD FOR PERFORMING PROJECT MANAGEMENT ATTENDANT TO ANY OF VARIOUS TYPES OF PROJECTS

(76) Inventor: Edward Ruben Mislavsky, Ocean, NJ (US)

(21) Appl. No.: 13/010,521

(22) Filed: Jan. 20, 2011

Related U.S. Application Data
(60) Provisional application No. 61/296,681, filed on Jan. 20, 2010.

(51) Int. Cl. G06Q 10/00

(52) U.S. Cl. 705/7.11

(57) ABSTRACT

Provided herein is a system, method and computer-readable-storage medium for performing project management of, and/or attendant to, one or more projects; each project including a set of tasks. The system may include a server having a framework adapted to configure the server to manage one or more aspects (e.g., any of a scope, cost and schedule) of, and/or attendant to, any project and/or portion thereof. The server, so configured, may manage the managed aspects in a number of ways. For example, the server may obtain, from one or more users, information associated with the set of tasks; apply one or more directives of the framework to the information to determine one or more states of, and/or attendant to, the managed aspects; compare the managed-aspect states to respective sets of predetermined conditions; and report at least an indication of the managed-aspect states responsive to such satisfying the sets of predetermined conditions.

### CROSS-REFERENCE TO RELATED APPLICATIONS

This application claims the benefit of U.S. Provisional Application Ser. No. 61/296,681, filed Jan. 20, 2010, entitled “System and Method for Managing Construction and Design Projects;” which is incorporated herein by reference in its entirety.

### BACKGROUND

1. Field

The following relates to a systems and methods for performing project management. More particularly, the following relates to a system method and computer-readable-storage medium for performing project management attendant to any of various types of projects, including, for example, construction and design projects.

2. Related Art

Design and/or construction projects of all sizes are notorious for running over budget and past deadlines for completion. Much of cost overruns and missed deadlines can be caused as a result of all parties not having timely access to appropriate and accurate information. Traditionally owners, design professionals, contractors, subcontractors, vendors, suppliers, sureties, and lenders have used spreadsheets, databases, and other limited tools in order to track the information needed to run construction and design jobs. Much of that information is accumulated in file folders and manual logs.

A significantly large amount of information is created and used during a life-cycle of a construction project (i.e., from a planning stage through design and construction stages to facility management). Existing systems for maintaining project files are not integrated and, as a result, information must be manually exchanged using legacy or single/limited function tools in multiple locations. This creates increased system complexity, a higher error rate, and a high financial risk to participants in construction projects.

Owners, for example, are presented with an enormous amount of risk on construction projects. First, they retain design professionals to prepare construction documents. Owners then contract with construction managers or contractors for the construction of the project. While owners have full financial responsibility, they often appear to be the least informed about the risks incurred during design and construction. Managing design and construction is a complex process. Information regarding critical issues often gets to the decision maker too late to adapt to the information without incurring additional costs. Thus, there is a need for a project management system and method that provide users with an integrated system to manage every phase of a project from concept to completion.

Design professionals are also limited by current systems and methods of project management. Design professionals engage in the formidable endeavor of preparing complete construction documents. The coordination of design disciplines along with a project's budget and schedule constraints make design tasks challenging. Design teams are also entrusted to process contractor submittals and clarification requests in support of the project's schedule. Most design teams are ill equipped to meet these tasks. Thus, there is also a need for a project management system and method that enable design professionals to successfully manage design, collaborate, and provide integrated delivery of services.

Further, contractors and subcontractors are often ill equipped to manage the administrative tasks of a project, yet they must guarantee performance. Contact requirements for submittals, schedule, payment, and changes can overwhelm even the most sophisticated team. Documents are scattered amongst different individuals and are usually not available when needed most. The unavailability of documents leads to miscommunication, additional costs, and project delays. Thus, there is a need for a project management system and method that provides contractors and subcontractors with access to an integrated set of modules to manage every aspect of a project, simplifying complicated tasks. In addition, vendors and suppliers are depended upon by contractors and subcontractors to meet schedules and budgets. However, contractors and subcontractors often do not keep vendors and suppliers informed of a project's latest requirements. Thus, there is a need for systems and methods that enable enabling vendors and suppliers to become aware of the requirements and responsibilities of and their scope while being more efficient with the delivery of their work.

In addition, on bonded projects, unexpected payment and performance bond claims increase financial risk of sureties, lenders and owners. By the time a notice of default, pending or actual termination, or payment bond claims are known, the opportunity to mitigate those risks is severely diminished. Thus, there is a need for systems and methods to enable sureties to monitor a bonded principal, to reduce the risk of financial losses through alerts, to efficiently manage the claim process, and transmit and receive information in real time accessible around the clock. Further, lenders are challenged by the risk that a project's committed loan funds will not be used as intended. If contractors, subcontractors, suppliers, or vendors do not get paid for services rendered, mechanic's liens, claims, and disputes raise the risk of financial exposure. Thus there is a need for systems and methods to enable lenders to monitor a project before the trouble starts by allowing them to receive early warnings regarding impending problems and to stay informed of progress.

Keeping separate records among all those involved in a construction or design project is an inefficient process because multiple parties must manually input the same data several times, thus creating multiple data entry error points or critical data being ignored due to complex formats or tracking requirements. In addition, multiple manual data entry significantly increases the likelihood of human error and therefore creates an unreliable source of data that may mislead decision-makers into making ineffective, inefficient or wrong decisions. As an example, requests for proposals and bids are due on a specified date and time. Preparation of submission documents and pricing is done at the last minute and last minute changes or revisions introduce errors in transposing data to the appropriate forms. Further, by creating project documents using discrete, single function, programs, a significant effort is required to develop transactional documents and status reports. With current legacy and limited function systems, multiple manual entry of data may also create a significant delay in the receipt of data by all parties.

Various computer systems have been developed and introduced by software or construction firms. However, many of these systems are effective only within certain narrow application. To illustrate, in order to accomplish such a construction project, each person in charge shares the project data with others, and keeps such data for his or her own use, and based on his allotted share of the work. However, the project activities are interrelated with each other in a complex manner so that it is very difficult for the other persons that need the same data to have information in common with each other. Such complexity is because the project data is stored, retrieved, computed and updated as the project progresses from the viewpoint of each person, in differing formats with respect to each particular piece of information.

Thus, there is a need for an integrated platform for all project data, improving and eliminating all duplicative manual data entry and allowing all parties access to a single source for accurate and timely project information.

### SUMMARY

A system, method and computer-readable-storage medium for performing project management of, and/or attendant to, one or more projects are provided. Any of these projects may be a construction and design (“C&D”) project, for instance. Each of the projects may include a set of tasks; successful completion of (some or all of) which may move the status or “state” of project towards satisfaction and/or achievement of its objectives and/or goals.

With regard to the system, the system may include a server-type computer (“server”) that, in turn, includes a framework (“project-management framework”). Execution of the project-management framework by the server may configure the server to manage one or more aspects (“managed aspects”) of, and/or attendant to, any project and portions thereof. These managed aspects may include, for example, any of a scope, cost and schedule attendant to such project or portion thereof. To facilitate managing the managed aspects, the framework may define one or more directives, settings, rules, expressions, characteristics, parameters, commands and the like (collectively “directives”).

The server, as configured, may manage the managed aspects in a number of ways. For example, the server may obtain, from one or more users of a set of users, information associated with the set of tasks (“task information”). The server may also apply one or more of the directives to the task information so as to determine one or more states (“managed-aspect states”) of, and/or attendant to, one or more of the managed aspects. The server may further compare the managed-aspect states to a set of predetermined conditions; and report at least an indication (“state indication”) of the managed-aspect states, responsive to the managed-aspect states satisfying one or more of the set of predetermined conditions.

### BRIEF DESCRIPTION OF THE DRAWINGS

So the manner in which above recited features of the present invention can be understood in detail, a more particular description of embodiments of the present invention, briefly summarized above, may be had by reference to embodiments, several of which are illustrated in the appended drawings.

Figures in the appended drawings, like the detailed description, are examples. As such, the Figures and the detailed description are not to be considered limiting, and other equally effective examples are possible and likely. Furthermore, like reference numerals in the Figures indicate like elements, and wherein:

FIG. 1 is a block diagram illustrating an example of a system for performing project management of, and/or attendant to, one or more projects;

FIG. 2 is a flow diagram illustrating an example flow for performing project management of, and/or attendant to, one or more projects;

FIG. 3 is a block diagram illustrating an example of a system for performing project management of, and/or attendant to, one or more projects;

FIG. 4A is a block diagram illustrating an example architecture of a server of a system for performing project management, such as the system of FIG. 1;

FIG. 4B is a block diagram illustrating an example of an architecture of a user device of a system for performing project management, such as the system of FIG. 1;

FIG. 5 is a flow diagram illustrating an example flow for performing project management of, and/or attendant to, one or more of projects;

FIGS. 6A-6D is a flow diagram illustrating an example flow for performing project management of, and/or attendant to, one or more projects;

FIG. 6E is a flow diagram illustrating an example flow for performing project management of, and/or attendant to, one or more projects;

FIGS. 7A-7E are flow diagrams illustrating a plurality of example flows for performing project management of, and/or attendant to, portions of a project;

FIG. 8A is a flow diagram illustrating an example flow for performing project management of, and/or attendant to, one or more projects;

FIG. 8B is a flow diagram illustrating an example flow for performing project management of, and/or attendant to, one or more projects; and

FIG. 9 is a flow diagram illustrating an example flow for performing project management of, and/or attendant to, one or more projects

Headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must).

### DETAILED DESCRIPTION

In the following detailed description, numerous specific details are set forth in order to provide a thorough understanding of embodiments or other examples described herein. In some instances, well-known methods, procedures, components and circuits have not been described in detail, so as to not obscure the following description.

Further, the examples disclosed are for exemplary purposes only and other examples may be employed in lieu of, or in combination with, the examples disclosed. It should also be noted the examples presented herein should not be construed as limiting of the scope of embodiments of the present disclosure, as other equally effective examples are possible and likely.

Overview

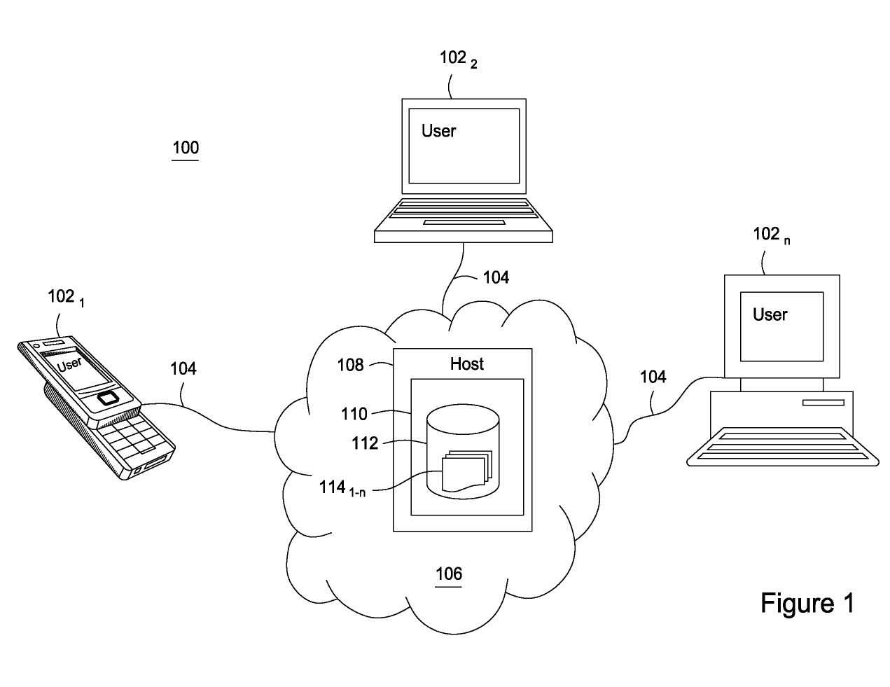

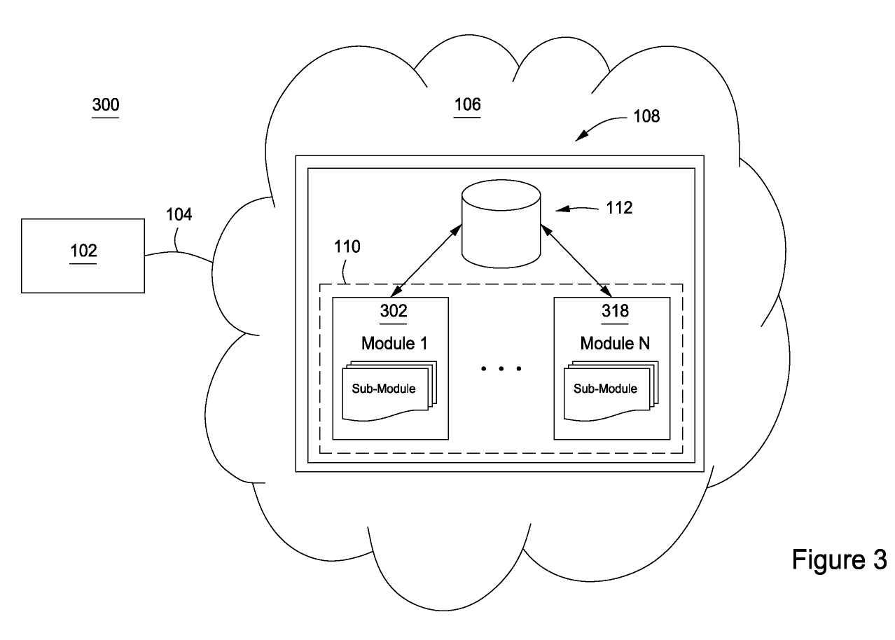

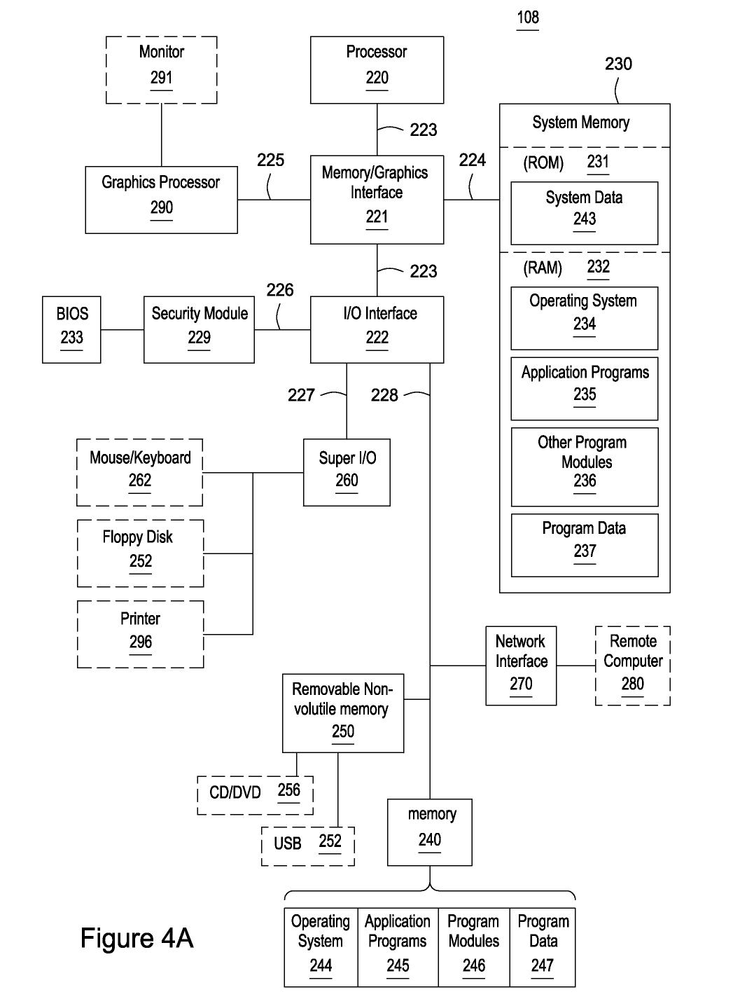

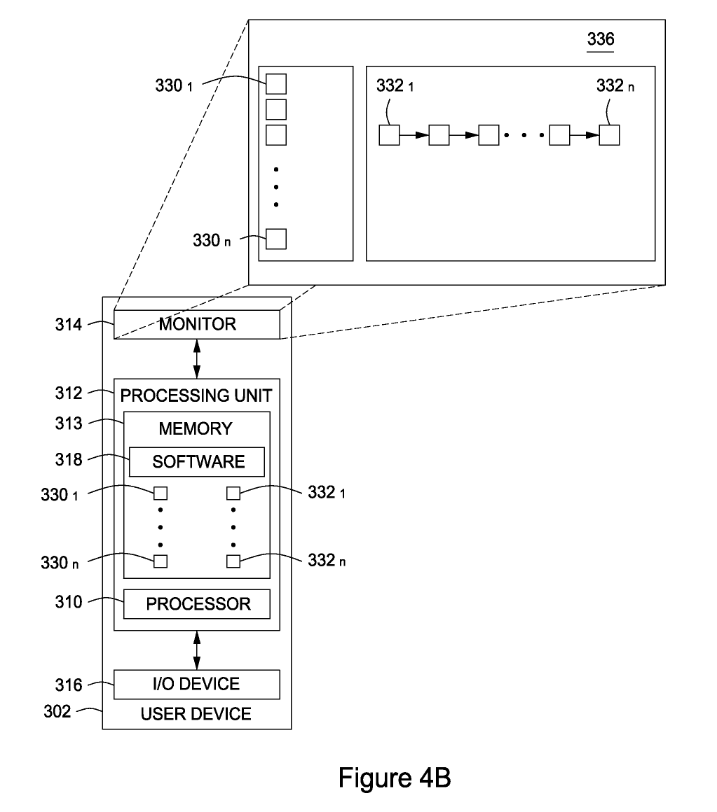

FIG. 1 is a block diagram illustrating an example of a system 100 for performing project management of, and/or attendant to, one or more projects. In general the project, as used herein, may refer to any undertaking to be performed over a period of time, and by way of example, the projects may include one or more construction and design projects (each a “C&D project”). The system 100 may include, for example, a host device (“host”) 108 and any number of user devices 102₁-102ₙ. For simplicity of exposition, however, only three of the user devices 102₁-102ₙ are shown in FIG. 1. Further, any of the user devices 102₁-102ₙ (shown or not shown) may be referred to hereinafter as “user device 102.” To not obscure the following description with details and/or features of an architecture of the system 100 here, additional details of example architecture of a system for performing project management of, and/or attendant to, one or more projects, which may be representative of the system 100 are described with reference to FIGS. 3-4.

In general, the host 108 may be one or more server-type computers (collectively “server”), and each of the user devices 102₁-102ₙ may be, for example, any of a personal computer; a portable computer, a handheld computer; a mobile phone, a digital assistant, a personal digital assistant, a cellular phone, a smart phone, a pager, a digital tablet, a laptop computer, an Internet appliance and the like.

The host 108 and any of the user devices 102₁-102ₙ may communicatively couple, via respective communication links of a network 106, and in turn, carry out one or more communications over the network 106. This way, the host 108 and any of user devices 102₁-102ₙ may exchange, i.e., send and/or receive, information (“project-management information”) associated with any of the C&D projects by way of such communications. To facilitate the exchange, the host 108 may be equipped with a web server, and any of user devices 102₁-102ₙ may connect to the web server using, for example, a web browser or other like-type user interface.

The host 108 may include, for example, a project-management framework 110 and a central repository 112. The central repository 112 may include records (“central-repository records”) 114ₙ; one for each of the C&D projects (referred to herein individually as a “central-repository record 114”). As described in more detail below, the project-management framework 110 may be adapted to configure the host 108, when executed thereby, to manage to one or more aspects (“managed aspects”) of, and/or attendant to, a portion or the entire C&D project. These managed aspects may be, for example, any of a scope, cost and schedule of, and/or attendant to, such portion or entire C&D project. The managed aspects may be other aspects of, and/or attendant to, the C&D project, as well. To facilitate managing the managed aspects, the project-management framework 110 may include one or more directives, settings, rules, expressions, characteristics, parameters, commands and the like (collectively “directives”) (not shown).

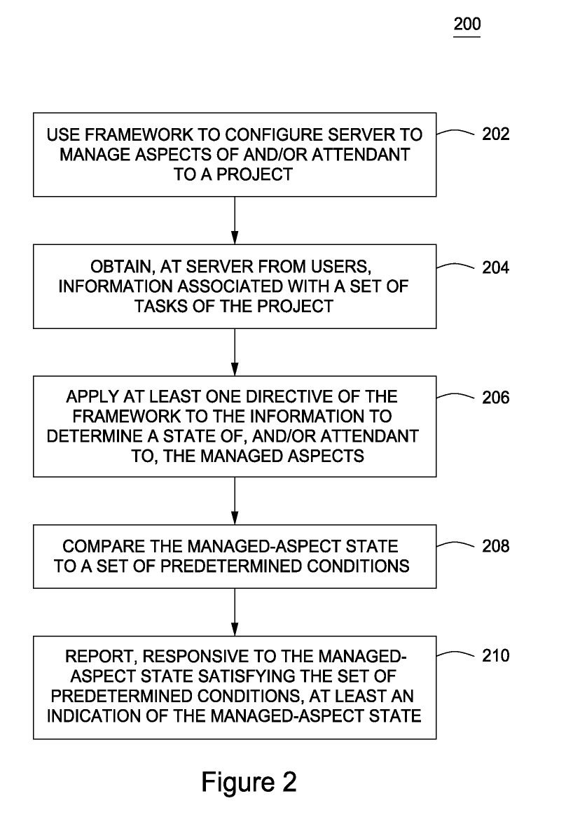

The host 108, as configured by the project management framework 110, may manage the managed aspects in a number of ways. An example of the host 108 managing the managed aspect is as described below with respect to FIG. 2.

Example Operation

Referring now to FIG. 2, a flow diagram illustrating an example flow 200 for performing project management of, and/or attendant to, one or more projects is shown. For convenience, the flow 200 of FIG. 2 is described with reference to the system 100 of FIG. 1. The flows 200, however, may be carried out using other architectures as well.

The flow 200 starts some time prior to process block 202, and then transitions to the process block 202. At the process block 202, host 108 executes the project-management framework 110, thereby configuring the host 108 to manage the managed aspects of, and/or attendant to, the C&D projects. Once configured, the host 108 is available to begin managing the managed aspects of, and/or attendant to, the C&D projects. After process block 202, the flow 200 transitions to process block 204.

At process block 204, the host 108 obtains the task information from one or more users associated with the C&D project (hereinafter “project participants”), via respective user devices 102₁-102ₙ. The project participants may be, for example, any of an owner, design professional, prime contractor, subcontractor, vendor, supplier, surety, lender and any other entity associated with the C&D project.

To facilitate obtaining the task information, the host 108 may prompt the project participants to login in by way of an electronic message or alert sent from the host 108 to user devices 102₁-102ₙ of the project participants, and once logged in, the host 108 may then prompt or otherwise request the project participants to enter the task information via their web browsers. The host 108 may request the project participants to enter or otherwise provide the task information at various times between a beginning and an end of the C&D project. For example, the host 108 may prompt or request the project participants to enter or otherwise input the task information at times sufficient to timely satisfy one or more of the set of tasks (e.g., when necessary and/or sufficiently in advance of deadlines defined by one or more of the tasks).

Responsive to its request(s), the host 108 may receive the task information sent by the project participants via the corresponding user devices 102₁-102ₙ. The host 108, subsequent to receipt, may collect, integrate into, update and/or maintain in the central-repository record 114 for the given C&D project, the task information received from the project participants. After the process block 204, the flow 200 transitions to process block 206.

At the process the block 206, the host 108 may apply one or more directives to the task information to determine the manage-aspects states of, and/or attendant to, the managed aspects. Each of the manage-aspects states may be a then current state of, for example, any of a scope, cost and schedule of, or attendant to, the C&D project, as a whole, the set of task associated with the received task information and/or another set of tasks. After the process block 206, the flow 200 transitions to process block 208.

At the process block 208, the host 108 may compare the managed-aspect states to a set of predetermined conditions. These predetermined conditions may include, for example, missing or incomplete task information, newly completed task information, impeding, past and/or long-term due dates, new task information required, payments available, claims submission incomplete and the like. After the process block 208, the flow 200 transitions to process block 210.

At the process block 210, the host 108 may report to one or more of the project participants at least an indication of the managed-aspect in response to one or more of the managed-aspect states satisfying one or more of the set of predetermined conditions. This report may be, for example, an electronic message and/or alert sent to such project participants, where the electronic message and/or alert includes one or more indicators (“state indicators”) indicative of the managed-aspect states. After receipt, the state indicators may be displayed to the project participants via their user devices 102₁-102ₙ. After the process block 210, the flow 200 may terminate.

Alternatively, the flow 200 may be repeated periodically, in continuous fashion, or upon being triggered as a result of a condition, such as a change in date or in task information. As another alternative, the process blocks 204-210 and/or process blocks 206-210 may be repeated periodically, in continuous fashion, or upon being triggered as a result of a condition, such as a change in date or in task information.

Referring back to FIG. 1, the project-management framework 110 may be adapted to also configure the host 108 to utilize central-repository record 114 to facilitate sharing and/or exchange of some or all of the project-management information among some or all of the project participants. Similarly, the project-management framework 110 configure the host 108 to may automatically perform a number of functions that require, as input, the project-management information from more than one (i.e., multiple) project participants, which is made possible as a result of the project-management framework 110 being able to collect, integrate and maintain such multi-user project-management information in the central-repository record 114. Depending on particularities of the C&D projects, some of these functions may be common to all of the C&D projects, while other functions may only be carried out in fewer than all of the C&D projects.

Some advantages of the project-management framework 110 include being able to automatically perform activities, such as bid submissions, bid tabulations and analysis, without double entry of data. This automation may eliminate entry errors and provide reliable information more quickly for improved decision making. Also, the system 100 is easy to use and intuitive, and generally eliminates training typically required for single function applications.

As described in more detail below, the project-management framework 110 may configure the server 108 so as to allow project participants, via browsers running on their user devices 102₁-102ₙ to simply login or otherwise access a project-management website running on the server 108 and interact with the project-management framework 110 to assist with the managing of the managed aspects of, and/or attendant to, the C&D project or portion thereof. Some of these functions may include preparing project budgets and schedules, and approve them electronically; preparing, receiving, submitting and evaluating proposals from design professionals; select design professionals and awarding contracts; managing design contracts and related activities; preparing, receiving, submitting, and evaluating construction bids; selecting construction firms and awarding contracts; and managing construction contracts and purchase orders, and related activities.

Example System Architecture

FIG. 3 is a block diagram illustrating example architecture of a system 300 for performing project management of, and/or attendant to, one or more projects, including, for example, one or more construction and design projects. The system 300 of FIG. 3 is similar to the system 100 of FIG. 1, except as described herein below. The system 300 may include, for example, the host 108 and any number of user devices 102₁-102ₙ (although only one user device 102 is shown). As above, the host 108 and any of the user devices 102₁-102ₙ may communicatively couple, via respective communication links of a network 106, and in turn, carry out one or more communications over the network 106.

The network 106 may include a partial or full deployment of most any communication network, computer network or convergence thereof, and may include any combination of a public or private, terrestrial wireless or satellite, or wireline network. As such, the network 106 may include network elements from a Public Switch Telephone Network (“PSTN”); the Internet; core and proprietary public networks; wireless voice and packet-data networks, such as 1G, 2G, 2.5G, 3G, and 4G telecommunication networks; wireless office telephone systems (“WOTS”) and/or wireless local area networks (“WLANs”), including, Bluetooth and/or IEEE 802.11 WLANs, wireless personal area networks (“WPANs”), wireless metropolitan area networks (“WMANs”) and the like.

These network elements may include circuit-switched as well as packet data devices (e.g., routers, switches and the like) to provide transport the project-management information, and may be configured to communicate such project-management information using any number of protocols and in any manner consistent with providing such information to the user devices 102₁-102ₙ and host 108. These protocols may include any of a standardized, proprietary, open-source, and freely-available communication protocol for communicating content in circuit-switching and/or packet data networks, and the like. Although shown in FIG. 3 as communication link 104 and a cloud, the network 106 may include a large number of other elements; most of which are not shown in FIG. 3 for simplicity of exposition.

Although the network 106 is shown as being contiguous, it may be a plurality of mutually exclusive networks, including, for example, autonomous systems and/or networks. In general, the network 106 provides, for entities that can connect to it, the ability to exchange communications with any of the user device 102, the host 108, and/or other node (not shown) communicatively coupled thereto.

The system 300 of FIG. 3 may be utilized to implement the systems and methods for project management disclosed herein. It should be noted, however, any transmission system, capable of transmitting bytes of data from a first device to a second device, over any physical medium, may be utilized in accordance with embodiments of the present disclosure. It is contemplated within embodiments of the present disclosure that any embodiment of the present disclosure or combination of embodiments may be implemented in the host 108.

The host 108 may include a processor 220 and memory 240, wherein the memory 240 is adapted to store the project management framework 110. The project-management framework 110 may include any of a project module 302, financials module 304, RFP (Request for Proposal) module 306, design module 308, bid module 310, construction module 312, reports module 314, notifications module 316 and claims module 318. Each of these modules 302-318, in general includes computer code, including instructions executable by the host 108 or equivalent device, and may be independently loadable from long-term storage media (such as, but not limited to, a disk drive, CD-ROM, tape, or the like). The modules 302-318 may also include subroutines, processes, Dynamic Link Libraries (DLLs) and the like.

The project module 302 may include a number of sub-modules. Each of these sub-modules is adapted to configure the host 108 with portions of the functionality of the project module 302, where such portions are similar in kind. Together project module 302 and the sub-modules (collectively “project module 302”) may be adapted to configure the host 108 to perform a number of functions. The functions may include, for example, any of providing a summary of common project information to all project participants; providing the task information to project participants without having to recreate such task information; sharing common data while maintaining contract confidentiality; providing a scope describing the project; providing project milestone dates; identifying the members of a project team; providing basic project data; providing a project title and address; providing an owner name and address; providing descriptions and categories for project comprising units used (English or SI); allowing users to use existing or create new codes to segregate/categorize work; allowing sharing of codes across companies; allowing creation of unique codes to each company; sharing common codes that may only be modified by an owner participant, removing the requirements for users to recreate code dictionaries.

Further, the project module 302 may be adapted to configure the host 108 to perform at least one of: allowing a user to define project areas; allowing a user to define project buildings or structures; allowing a user to define elevations for a building or structure; allowing a user to define the floors in a building or structure; allowing a user to define rooms in a floor; adding a work breakdown structure (WBS) adapted to add new codes that may be shareable across project; adding a team member; identifying members of project team; defining company and project roles that may be shareable across project.

In addition, the project module 302 may be adapted to configure the host 108 to perform at least one of: allowing development of a project schedule that may be shareable across a project; allowing users and companies to share a common schedule; providing unique company schedules to a controller of project schedule; allowing users to identify major project milestones, which may be shareable across a project; allowing users to enter new milestone activities; allowing sharing of data across all project users per designation of milestone creator; allowing identification of schedule tasks that may be shareable across project; adding a new schedule task; allowing input of a description and an activity number; adding a start date and an end date, or duration and successor/predecessor logic relationship; notes; calculating the schedule dates based on input of task data and network logic using the Critical Path Method; enabling linking, acceptance and integration of lower tier schedule data; allowing uploading and cataloguing of images that may be shareable across project; providing linking of project specific data/information, for example, title, description, daily report, schedule, to an image; allows a user to add an image.

The project module 302 may also be adapted to configure the host 108 to perform at least one of: providing a means to schedule meetings and invite members; automating creation of an agenda based on existing project data or allowing entry of new data; allowing users access to and the ability to add current art, for example, spreadsheets or text documents that are manually updated; adding new meeting invites to members; providing time, location, and agenda of meetings; notifying users automatically based on a creator's invitee list; eliminating a requirement to generate new e-mails or documents; allowing users to (i) access or add meeting details, (ii) add an activity entry of item from prior meeting or issues; (ii) submit requests for information, clarification and/or interpretation (collectively “RFI”), and (iii) submit schedules, changes, and punch list items; and the like.

The project module 302 may be adapted to configure the host 108 with directives (“project-definition directives”) for determining the managed-aspect states of, and/or attendant to, the project-definition aspects, and the predetermined conditions (“project-definition pre-conditions”) associated with the set of project-definition tasks. The project-definition directives and project-definition pre-conditions may include, for example, directives and pre-conditions for the functionalities that the project module 302 provides toward configuration of the host 108.

The financials module 304 may include a number of sub-modules. Each of these sub-modules is adapted to configure the host 108 with portions of the functionality of the financials module 304, where such portions are similar in kind. Together financials module 304 and the sub-modules (collectively “financials module 304”) may be adapted to configure the host 108 to provide a set of financial data to one or more project participants. The financials module 304 may also be adapted to configure the host 108 to perform at least one of: providing unique financial information to each company, wherein the financial information may be controlled by each company and by uniquely authorized project participants of each company; allowing authorized users to establish view and access rights to the financial information/data; providing a consolidated financial position based on budgets, estimates, contracts and/or other data provided by the project participants; providing a summary of financial status for company wherein the consolidated summary is based on real time based on contract and/or other financial commitments; allowing authorized project participants of a company to control access to the summary of financial status and consolidation financial position; providing a scope description; identifying project participants from companies that have access to task and other project information; allowing creation of project budgets and/or estimates, wherein budget or estimate lines may be established by identifying quantities, and either summary unit costs, or detailed production rates and material, labor, equipment, subcontract and other unit costs; assigning codes are by preexisting drop down list or import of company list; allowing approval of budget or estimate at the line item level.

Further, the financials module 304 may be adapted to configure the host 108 to perform at least one of: cloning of line items; combining of line items; adding a new budget or estimate; allowing development of revised budget or estimate; importing old information or allowing starting with new information; selecting an existing budget or estimate summary; providing a summary of budget or estimate by category; providing the status of a budget or estimate; adding a budget or estimate line can be accomplished by selecting detailed or summary format; allowing selected rows to “clone” an entry multiple times and automatically revise the description based on prefix or suffix and number entry; combining selected rows combine existing line items; “de-combining” combined items; individually approving budget or estimate lines; comparing all forecast costs against budget or estimate; initializing using an approved budget or estimate as a baseline; adding forecast adjustments; updating forecasts at individual budget or estimate line item; keeping chronology of adjustments and transfers from categories; assigning cost changes or potential changes to forecasts by linking to project data; funding module assigns funding sources to project; linking to/from project participants providing funding and adding funding.

The financials module 304 may be adapted to configure the host 108 with directives (“financials directives”) for determining the managed-aspect states of, and/or attendant to, the financials aspects, and the predetermined conditions (“project-definition pre-conditions”) associated with the set of financials tasks. The financials directives and financials pre-conditions may include, for example, directives and pre-conditions for the functionalities that the financials module 304 provides toward configurations of the host 108.

The RFP module 306 may be adapted to configure the host 108 to manage the managed aspects (“RFP aspects”) of, and/or attendant to, any portion of the project associated with the RPFs thereof. The RFP module 306 may include an RFP summary sub-module 306₁, an RFP creation sub-module 306₂, an RFP submission sub-module 306₃, and an RFP evaluation sub-module 306₄ (collectively “RFP sub-modules 306₁₋₄”). The RFP module 306 may include other sub-modules, as well.

The RFP summary sub-module 306₁ may be adapted to configure the host 108 to provide a summary of task information in the form of information associated with a set of RFP tasks (“RFP-task information”). The RFP-task information provided by way of the RFP summary sub-module 306₁ may include a definition of requirements for the RFPs, which may be extracted from the central repository 112.

The RFP summary sub-module 306₁ may configure the host 108 with functionality for any of: adding and listing new RFPs for design services; providing, to the project participants an indication or electronic notification of a RFP's due date and time; allowing RFPs to be listed on-line; provide analysis (instant or otherwise) after bid due dates; and the like.

The RFP summary sub-module 306₁ may also configure the host 108 to obtain from, and allow exchange among, the project participants, the RFP-task information. This may include configuring the host 108 to provide to the project participants online forms or other like-type structures for entry of RFP details, and submission of completed proposals.

The RFP creation sub-module 306₂ may be adapted to configure the host 108 to manage the RFP aspects associated with the creation of RFPs. The RFP creation sub-module 306₂ may configure the host 108 to obtain from, and allow exchange among, the project participants, the RFP-task information. This may include configuring the host 108 to (i) provide to the project participants online forms or other like-type structures for entry and storage of RFP details; and/or (ii) permit uploading of electronic forms of documents for RFP preparation and creation. Entry and storage of the RFP details may include entry of descriptions of RFPs; entry of details describing the scope of services requested; entry of RFP scheduling for conferences and due dates, time and location; and the like.

The RFP creation sub-module 306₂ may also configure the host 108 with functionality for providing, to the project participants, any of a summary and/or an overview of requirements and list of proposers, details describing the scope of services requested, RFP scheduling for conferences and due dates, time and location, breakdowns for RFP analysis. The RFP creation sub-module 306₂ may further configure the host 108 with functionality for any of: evaluation categories and assigning weight of importance to each category and allowing companies to invite a proposer to enter a company and key individuals to invite participation; and the like.

The RFP submission sub-module 306₃ may be adapted to configure the host 108 to manage the RFP aspects associated with the submission of proposals. The RFP submission sub-module 306₃ may configure the host 108 to obtain from, and allow exchange among, the project participants, the RFP-task information associated with proposals. This may include configuring the host 108 to (i) provide to the project participants online forms or other like-type structures for entry and storage of proposal details; and/or (ii) permit uploading of electronic forms of documents for proposal preparation and submission.

The RFP submission sub-module 306₃ may configure the host 108 with functionality for any of: selecting existing RFPs; providing a proposers list of companies invited and those that accepted; allowing invited proposers to see a RFP package; allowing non-subscribers to receive an e-mail of invite; providing details describing the scope of services provided; providing participants access to enter certification text for proposers to use in certifying a proposal; providing a breakdown for RFP submission; allowing proposers to develop design budgets; adding details of design stage, discipline, task and subtask, which may be predefined to budget items; enabling cloning of budget lines and editing descriptions by adding a prefix or suffix with numeric sequence to description; allowing linking of design budget line items to the RFP breakdown; and the like.

The RFP evaluation sub-module 306₄ may be adapted to configure the host 108 to manage the RFP aspects associated with the evaluation of proposals. The RFP evaluation sub-module 306₄ may configure the host 108 with functionality for any of: enabling analysis based on detailed or summary budgets; providing evaluation lists for submitted RFPs with scores for fee and rank for categories; providing instant analysis of proposals based on selected criteria and fee analysis (e.g. showing the top five firms side-by-side for comparison); providing parametric analysis of bid; comparing selected submissions; for selected firms, by score and fee, highlighting a best score for each firm; notifying selected firm of contractee's intent to award contract; and the like.

The RFP module 306, and in turn, the RFP sub-modules 306₁-4 may be adapted to configure the host 108 with directives (“RFP directives”) for determining the managed-aspect states of, and/or attendant to, the RFP aspects, and the predetermined conditions (“RFP pre-conditions”) associated with the set of RFP tasks. The RFP directives and RFP pre-conditions may include, for example, directives and pre-conditions for the functionalities that the RFP module 306 and the RFP sub-modules 306₁₋₄ provides toward configuration of the host 108.

The design module 308 may be adapted to configure the host 108 to manage the managed aspects (“design aspects”) of, and/or attendant to, any portion of the project associated with the design thereof. The design module 308 may include a design summary sub-module 308₁, a design agreement sub-module 308₂, a design scope sub-module module 308₃, a design budget sub-module 308₄, a design scheduling sub-module 308₅, a design drawings sub-module 308₆, a design specifications sub-module 308₇, a design submittals sub-module 308₈, a design miscellaneous sub-module 308₉, a design issues sub-module 308₁₀ and a design invoices sub-module 308₁₁ (collectively “design sub-modules 308₁₋₁₁”). The design module 308 may include other sub-modules, as well.

The design summary sub-module 308₁ may be adapted to configure the host 108 to provide a summary of task information in the form of information associated with a set of design tasks (“design-task information”). The design-task information provided by way of the design summary sub-module 308₁ may include any of: a description of the project; a scope of design services required; a definition of a design schedule; a definition of a design budget; a definition of an invoicing-fee schedule; and one or more definitions of design documents, which by way of example, may include agreements and related documents, sketches, renderings, drawings, specifications and the like.

The design agreement sub-module 308₂ may be adapted to configure the host 108 to facilitate agreement negotiations by and between potential design-professional participants and owner participants with respect to some or all of the project design, and to facilitate execution of agreements by and between awarded design-professional participants and owner participants. For example, the design agreement sub-module 308₂ may configure the host 108 to obtain from, and allow exchange among, the project participants, e.g., the potential design-professional participants and/or owner participants, the design-task information associated with agreements. This may include configuring the host 108 to (i) provide to the project participants online forms or other like-type structures for entry of agreement details and documents providing scope and space to define key provisions of the agreements; and/or (ii) permit uploading of agreement documents in electronic form.

The design scope sub-module 308₃ may be adapted to configure the host 108 to provide to the project participants, e.g., the awarded design-professional and owner participants, the design-task information associated with the scope of the set of design tasks. This design-task information may include any of: design fees earned by one or more of the project participants; a design summary describing any of: a summary of work, schedule, budget and fees earned; and one or more work summaries sorted by, for instance, one or more predefined disciplines.

The design budget sub-module 308₄ may be adapted to configure the host 108 to manage the design aspects associated with the design budget. The design budget sub-module 308₄ may, for example, configure the host 108 to obtain from, and allow exchange among the project participants, e.g., the awarded design-professional participants and/or owner participants, the design-task information associated with the design budget. This design-task information may be in the form of a detailed budget for developing a schedule of values. The design budget sub-module 308₄ may also configure the host 108 to provide to the project participants a summary of fees, budget and actual costs.

The design scheduling sub-module 308₅ may be adapted to configure the host 108 to manage the design aspects associated with the design schedule. The design scheduling sub-module 308₅ may configure the host 108 to instantiate the design schedule. This may be done, at least initially, by importing from the central repository 112 the task information associated with the proposal submitted by the awarded design-professional participant. This task information may include the approved fee, schedule and/or budget information.

The design scheduling sub-module 308₅ may also configure the host 108 to obtain from, and allow exchange among, the project participants, the design-task information for further developing the design schedule. For example, the design scheduling sub-module 308₅ may configure the host 108 with functionality to allow a design team to share scheduling; to add new contract milestones; to add new contract tasks; to add new scheduling items; and the like. The design scheduling sub-module 3085 may also configure the host 108 to provide to the project participants a summary of the milestones for the design schedule along with a comparison of such milestones to actual dates.

The design drawings sub-module 308₆ may be adapted to configure the host 108 to manage the design aspects associated with the design drawings. This may include configuring the host 108 to obtain from, and allow exchange among, the project participants, the design-task information for the design drawings. For example, the design drawings sub-module 308₆ may configure the host 108 with functionality for any of: uploading and storing, in the appropriate records in the central repository 112, some or all drawings issued for the project; allowing drawings to be viewable on demand with any of: the user devices 102₁-102ₙ; adding and uploading new drawing created by the project participants; allowing entry of data applicable to drawing and/or notes; selecting existing drawing details; providing version control for drawings; testing files with CRC check calculation to verify revision history; allowing issuance of revised document; issuing, to project participants, some or all revisions to design tasks and documents; tracking drawing revision changes; downloading a latest revision history and issue revision number of the drawings and the like

The design specifications sub-module 308₇ may be adapted to configure the host 108 to manage the design aspects associated with the design specifications. This may include configuring the host 108 to obtain from, and allow exchange among, the project participants, the design-task information for the design specifications. For instance, the design drawings sub-module 308₆ may configure the host 108 with functionality for any of: uploading and storing, in the appropriate records in the central repository 112, some or all specifications issued for the project; allowing specifications to be viewable on demand with any of: the user devices 102₁-102ₙ; adding and uploading new specifications created by the project participants; allowing entry of data applicable to specifications; selecting existing specification details; downloading latest revision history; allowing issue revision; providing version control for specifications; testing files with CRC check calculation to verify revision history, allowing issuance of revised document; issuing, to project participants, some or all revisions to design-specification tasks and documents; tracking drawing revision changes; downloading a latest revision history and issue revision number of the specifications and the like.

The design submittals sub-module 308₈ may be adapted to configure the host 108 to manage the design aspects associated with the design submittals. This may include configuring the host 108 to obtain from, and allow exchange among, the project participants, the design-task information for the design submittals.

The design submittals sub-module 308₈, for example, may configure the host 108 with functionality for any of: allowing identification of required submittals; identifying contractor submittal requirements and linking to specifying document(s); adding new required submittal; adding new required submittals by providing to the project participants via their respective user devices 102₁-102ₙ, title and drop down of required submittals; allowing comments for required submittals; keeping track of design submittals for the project and for their approval process; selecting existing submittals issues for tracking related design issues;

The design other documents sub-module 308₉ may be adapted to configure the host 108 to manage the design aspects associated with other documents documents of the project design. To facilitate this, the design other documents sub-module 308₉ may configure the host 108 to obtain from, and allow exchange among, the project participants, the design-task information for such other documents. For instance, the design other documents sub-module 308₉ may configure the host 108 with functionality for any of: obtaining and storing, in the appropriate records in the central repository 112, the information from some or all information of the other documents documents issued for the project; selecting any of: the existing other documents documents; providing details of the other documents documents; and the like.

The design issues sub-module 308₁₀ may be adapted to configure the host 108 to manage the design aspects associated with the design issues. To facilitate such management, the design issues sub-module 308₁₀ may configure the host 108 to obtain from, and allow exchange among, the project participants, the design-task information for the design issues. The design issues sub-module 308₁₀ may, for example, configure the host 108 with functionality for any of: allowing access to action items and responsible parties or individuals; adding new issue to the project; allowing project participants (e.g., an initiator) to designate an issue as resolved; allowing an initiator or other authorized project participant to assign action items; allowing addition of new action items relative to an issue; and the like.

The design issues sub-module 308₁₀ may also configure the host 108 with functionality for reporting, to the project participants, project-issues listings with due dates and assignment of responsible parties or individuals; identifying a number of open action items against an issue; notifying project participants of issues at certain times and in any number of ways, including, for example, immediately via a notification tab of a page of the project-management website; and the like.

The design invoices sub-module 308₁₁ may be adapted to configure the host 108 to manage the design aspects associated with the design invoices. The design invoices sub-module 308₁₁ may configure the host 108 to obtain from, and allow exchange among, the project participants, the design-task information for the design invoices. To facilitate this, the design invoices sub-module 308₁₁ may provide the host 108 with functionality for any of: allowing preparation of invoices and submittal for approval; allowing review of invoices by project participants, who are contractees; allowing approval or returning of submitted invoices; and the like.

The design invoices sub-module 308₁₁ may also configure the host 108 with functionality for tracking of payments against each submitted invoice; and reporting to, and/or notifying, the contractee-project participants when invoices and/or payments will become due; and the like.

The design module 308, and in turn, each of the design sub-modules 308₁₋₁₁ may also be adapted to configure the host 108 with directives (“project-design directives”) for determining the managed-aspect states of, and/or attendant to, the project-design aspects, and the predetermined conditions (“project-design pre-conditions”) associated with the set of design tasks. The project-design directives and project-design pre-conditions may include, for example, directives and pre-conditions for the functionalities that the design module 308 and the design sub-modules 308₁₋₁₁ provide toward configuration of the host 108.

The bid module 310 may be adapted to configure the host 108 to manage the managed aspects (“bid aspects”) of, and/or attendant to, any portion of the project associated with the bids thereof. By way of example, the bid module 310 may be adapted to configure the host 108 to obtain from, and allow exchange among, the project participants, a set of submissions of bids; receive an indication of a bid due date; and provide analysis of the set of submissions of bids to a user after the bid due date and/or time. The bid module 310 may also be adapted to configure the host 108 to perform substantially the same or similar features as the RFP modules as applied to construction projects.

The bid module 310 may include a bid listing sub-module 310₁ and a bid submission sub-module 310₂ (collectively “bid sub-modules 310₁₋₂”). The bid module 310 may include other sub-modules, as well.

The bid listing sub-module 310₁ may be adapted to configure the host 108 to manage the bid aspects associated with the bid listings. The bid listing sub-module 310₁ may configure the host 108 to obtain from, and allow exchange among, the project participants, the bid-task information for the bid listings. To facilitate this, the bid listing sub-module 310₁ may provide the host 108 with functionality for any of: adding new bids, including entry of new bid title and requirements for bidding; and the like.

The bid listing sub-module 310₁ may also configure the host 108 with functionality for providing integrated bid management; managing linked drawings; providing, to the project participants, scope requirements, scheduling requirements, certification requirements, submission requirements, access to drawings, existing drawings, specifications comprising existing specifications and/or managed linked specifications and bid breakdowns; and the like.

The bid submission sub-module 310₂ may be adapted to configure the host 108 to manage the bid aspects associated with the bid submissions. The bid submission sub-module 310₂ may configure the host 108 to obtain from, and allow exchange among, the project participants, the bid-task information for the bid submissions. To facilitate this, the bid submission sub-module 310₂ may provide the host 108 with functionality for any of: selecting an existing bid; choosing items to link to a bid; selecting all documents, managed documents, linked documents, allowing access to companies, including invitees to this package; allowing project participants to choose items to link to this bid;

The bid submission sub-module 310₂ may also configure the host 108 with functionality for allowing preparation of bid estimates to link to bid breakdown renumbering estimate, if required, to link to bid breakdown; cloning selected rows of estimated lines; providing evaluation, including selecting bidders by comparing selected submissions to budget; providing instant evaluation of bid submissions, highlighting of lowest line items, unit pricing, and other items; providing parametric and statistical analysis of bids; providing, to the project participants, any of: a summary, status, scope, schedule and applicants' information; closing the bid; and the like.

The bid module 310, and in turn, the bid sub-modules 310₁₋₂ may be adapted to configure the host 108 with directives (“bid directives”) for determining the managed-aspect states of, and/or attendant to, the bid aspects, and the predetermined conditions (“bid pre-conditions”) associated with the set of bid tasks. The bid directives and bid pre-conditions may include, for example, directives and pre-conditions for the functionalities that the bid module 310 and the bid sub-modules 310₁₋₂ provide toward configuration of the host 108.

The construction module 312 may include a number of sub-modules. Each of these construction sub-modules is adapted to configure the host 108 with portions of the functionality of the construction module 312, where such portions are similar in kind. Together construction module 312 and the sub-modules (collectively “construction module 312”) may be adapted to configure the host 108 to integrate contract management of multiple contracts. The construction module 312 may be adapted to configure the host 108 to perform at least one of: providing an integrated multiple contract management function; selecting existing contact lists of existing contracts and related subcontracts; providing a summary including a scope summary, lists of key contract provisions, a contract cost summary customized for contractee role, a schedule comprising a number of contract milestones, a number of change order summaries, identification of a number of total issues and how many are open, a number of bids and how many RFIs are unresolved, and a number of punch list items, how many punch list items are completed, and how many punch list items are accepted.

Further, the construction module 312 may be adapted to configure the host 108 to perform at least one of: providing contract documents; compiling contract, schedule, and payment data (individually or collectively) to identify risk of default of the project; issuing a report or an alert notifying that the project is at risk of default and/or providing therein indications of performance and/or payment bond failure risk; providing a project summary; providing a contract summary and an ability to identify key contract provisions; providing the ability to hide summary to go to contract document listings; providing a jump to specifications; providing a jump to drawings; providing a jump to other documents; and providing a jump to change orders.

In addition, the construction module 312 may be adapted to configure the host 108 to perform at least one of: providing a summary of directives; change order requests, change order estimates, and approved change orders. For example, by summarized on a main screen; providing details and history for change orders; selecting existing change order by providing details of change orders and including attached documents, and provides the ability to attach documents; adding new change order by initiating change orders; selecting directives by allowing directives to be included in change orders; selecting approved change order requests by allowing change order requests to be included in change orders; initiate unrelated change orders by allowing initiation of change orders without reference to prior document(s); initiating related change order by creating the change order from the selected documents, allowing entry of data for contract modification, and allowing entry of funding source and subtracting funds from an account, but if unfunded, providing for negative forecast; selecting existing directive by providing data about a number of existing directives; approving change order by allowing a transfer of a directive to a change order after it is issued; adding a document by allowing addition of document for directive in progress and prior to issue; adding new directive by entry of a new directive and related documents; allowing change order requests issued by contractors.

Further, the construction module 312 may be adapted to further configure the host 108 to perform at least one of: selecting existing change order requests; exchanging change order requests between parties; comparing change order requests to independently produced estimates; and subsequently approving or rejecting the change requests; enabling automatic limiting of contractors to contract limits on overhead and profit, and contract unit prices by using change order requests; allowing requests from contractor by allowing contractors to develop change order requests and attach relevant documents; providing cost breakdown from contractor estimate; providing change order estimates by allowing parties to develop independent change order estimates, contractees to compare contractor's submission, and contractors to provide breakdown of costs; providing existing change order estimates by listing all change order estimates; allowing adding of new estimates by adding new change order estimates; allowing new estimate titles; allowing line item details by adding line title and codes from a drop down list, and detailed description; allowing entry based on composite unit price or detailed breakdown of material, labor production and unit costs, equipment and other costs for each line item; computing costs as data is entered; allowing cloning or combining of line items; allowing entry of scheduling impacts at the line item level; allowing payment by allowing contractee and contractor to review, approve, and process applications for payment electronically; initiating a first application by allowing a contractor to develop a first application based on bid breakdown or estimate; allowing a contractee to review, and approving or rejecting contractor's submission, wherein approved submissions provide the schedule of values that are the basis for payment, wherein line items may be automatically split into many lines with appending of prefix or suffix plus counter, into material and labor based on desired percentages and appending of material or labor label, and wherein unbilled items can be split or cloned at a later date into more detail, wherein new line items maintain same line number with decimal counter; providing lists of applications by listing all applications submitted, amounts requested, amounts paid, amounts remaining and status, wherein flags are provided based on contract requirements, providing sureties and lenders with payment bond or lien exposures due to lack of payment to lower tier contractors.

The construction module 312 may be adapted to also configure the host 108 to perform at least one of: providing a financial summary by providing specific information for each application, wherein the information may include a period of performance, payment data, progress to date, retainage withheld, or the like; allowing the financial summary to be hidden to display only details for each application; allowing entry of online lien and claim releases or upload of releases; providing line item details by listing each line item, wherein selecting an item may provide history for that item including actual costs incurred, and submission/approval/rejection for each; displaying rejected line items are shown in a predetermined color for example, against a pink colored background; displaying accepted lines in a predetermined color, for example, against a green background; displaying newly changed items in a predetermined color, for example against a pink background; cloning or splitting of line unbilled may be done at this level.

The construction module 312 may be adapted to configure the host 108 to perform at least one of: allowing hiding of summary information for viewing the line items only; printing an application; allowing creation of contract schedule; allowing a contractee to insert contractor's schedule into project or contractee's schedule, thus eliminating sneaker net transfer of scheduling data; automatically integrating a contract, a payment and a set of scheduling data; providing contract milestones that may be imported from a contract; adding new milestones; providing project milestones by importing project milestones, if desired by a contractor; adding new project milestones by allowing a contractee to add new milestones; providing contract tasks by adding a new scheduling item by adding a new schedule of tasks; importing from application for payment (“AFP”) to create schedule from approved payment application line items; distinguishing between delivery and installation activities and creating contract workflows tasks or requirements; calculating scheduling logic based on critical path method; providing an update by selecting a task, enabling updating of a task, adding of notes, and including data from daily reports; identifying required submittals during contract document creation and maintaining revision control; selecting existing submittal by providing submittal details, download submission allowing scanning of documents into a system; providing contractee response by allowing reply for acceptance or rejection of submittal wherein all previously submitted documents are viewable; providing revision history providing chronology for submittal; identifying and keeping track of project issues; adding new issues by permitting entry of new issues and using project categories or a new category to categorize, wherein users can view all items or open items; notifying selected users as soon as an item is issued wherein the assigning user is the only one who can close an issue; allowing a user to enter a brief description; providing a date identified; providing a date due; providing a category drop down list to categorized by discipline; providing a description; selecting users to notify and identifies users who are involved; selecting existing issue; marking an issue resolved; allowing an initiator to close out issue; adding action item; allowing involved users to assign action items against the issue, wherein the assigner is the only user who may close an action item; allowing contractors to initiate RFIs; allowing a contractee to respond to RFI; allowing entry of an RFI with reference to drawings and specifications which are provided via drop down boxes; allowing users to select multiple documents; allowing users to enter requested information; provide a suggested response if available; and identify users to notify.

In addition, the construction module 312 may be configured to perform at least one of: selecting existing RFI; allowing users to view and provide updates to RFI; allowing users to view all or only unresolved or open RFIs; allowing users to identify Non Conforming Items (NCIs); selecting existing NCI shows existing NCIs; provide non-conforming item status; provide an action listing showing the chronology of actions taken against NCI; adding new action; allowing involved users to assign actions against NCI; assigning responsibility to one user; notifying many users; adding a new NCI; allowing addition of new NCI and assigning to one user; providing a unique item designator; providing a date identified; providing a date due; providing a category; providing a description; selecting users to notify; providing a punch list; allowing users to create and update punch lists; selecting existing punch list items; allowing selection of an item to view details; providing notes & history allowing addition of notes and keeping chronology; providing images; allowing addition of images; keeping chronology; allowing contractor to report completion date; providing acceptance; allowing contractee an accept or reject completion; upon rejection, reported completed date is cleared, but chronology may show all actions and notes; allow viewing of open items only or showing all items; allowing addition of punch list items; provide punch list number; providing punch list title; providing date identified; provide expected completion; providing codes wherein codes are those established by the project or contract and a user may select multiple codes; allowing entry of notes (date & description); allowing upload of images (date, description and file); allowing images to be viewable on demand; selecting users to notify by identifying users involved with an item; providing daily progress by tracking daily progress as reported by a user; allowing multiple users to report; automatically logging and tracking weather at three time periods; selecting existing daily report; adding image title, file, description; adding daily report comprising a date, status, work performed; allowing entry of activities from schedule; allowing entry of activities not on schedule; allowing entry of status via a drop down menu; schedule module keeps track of information from daily reports; allowing entry of deliveries for items on schedule or not; allowing entry of time worked by workers; remembering/storing new workers once entered; allowing identification of activity from scheduling or newly entered activity; allowing entry of images from job site (title, description and file); providing trouble and delaying factors by allowing discrete identification of trouble and delaying factors; allowing notification to users of trouble and delaying factors; providing information from others by allowing discrete identification of information or direction received from others.

The construction module 312 may be adapted to configure the host 108 with directives (“construction directives”) for determining the managed-aspect states of, and/or attendant to, the construction aspects, and the predetermined conditions (“construction pre-conditions”) associated with the set of construction tasks. The construction directives and construction pre-conditions may include, for example, directives and pre-conditions for the functionalities that the construction module 312 provides toward configuration of the host 108.

The reports module 314 may include a number of sub-modules. Each of the reports sub-modules is adapted to configure the host 108 with portions of the functionality of the reports module 314, where such portions are similar in kind. Together reports module 314 and the sub-modules (collectively “reports module 3”) may be adapted to configure the host 108 to allow a project participant to generate customizable reports. The reports module 314 may also be configured to perform at least one of: allowing creation of preformatted reports or via report generator by linking data across many areas that share common fields; providing a project status; providing a budget status; providing a schedule status; providing exceptions; providing applications for payment; providing early warning; providing contract performance; providing meeting minutes; providing submittal status; and proving alerts.

The notifications module 316 may include a number of sub-modules. Each of the notifications sub-modules is adapted to configure the host 108 with portions of the functionality of the notifications module 316, where such portions are similar in kind. Together notifications module 316 and the sub-modules (collectively “notifications module 302”) may be adapted to configure the host 108 to provide a first project participant with a listing of current notifications sent by at least one other project participant. The notifications module 316 may be adapted to configure the host to perform at least one of: providing project participants with a listing of current notifications sent by others, wherein selecting of item takes a project participant to a particular item for an action, either approval/acceptance or rejection; tracking actions by system tabs feature uniqueness.

The claims module 318 may include a number of sub-modules. Each of the claims sub-modules is adapted to configure the host 108 with portions of the functionality of the claims module 318, where such portions are similar in kind. Together claims module 318 and the sub-modules (collectively “claims module 302”) may be adapted to configure the host 108 to notify a project participant of a number of claims. The claims module 318 may also be adapted to configure the host 108 to perform at least one of: identifying claims by selecting an icon from tabs, wherein depending on the circumstance, claims are categorized as payment bond claim, performance bond claim, and/or affirmative claim; claims may be further categorized by claim issue such as differing site conditions or similar categories; allowing notification per key contract provisions identified under the contract tab; creating electronic files of all documents with a numbering, for example, Bates numbering; preparing claim documents that may include summary and detail itemization of claims filed.

Alternative Example Operation

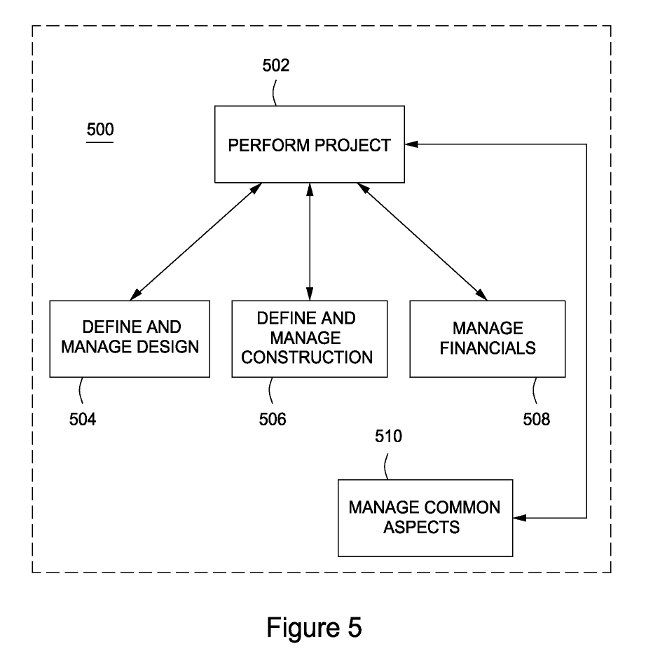

FIG. 5 is a flow diagram illustrating an example flow 500 for performing project management of, and/or attendant to, one or more of the C&D projects. For convenience, the flow 500 is described with reference to the system 100 of FIGS. 1 and 3-4. The flow 500, however, may be carried out using other architectures as well.

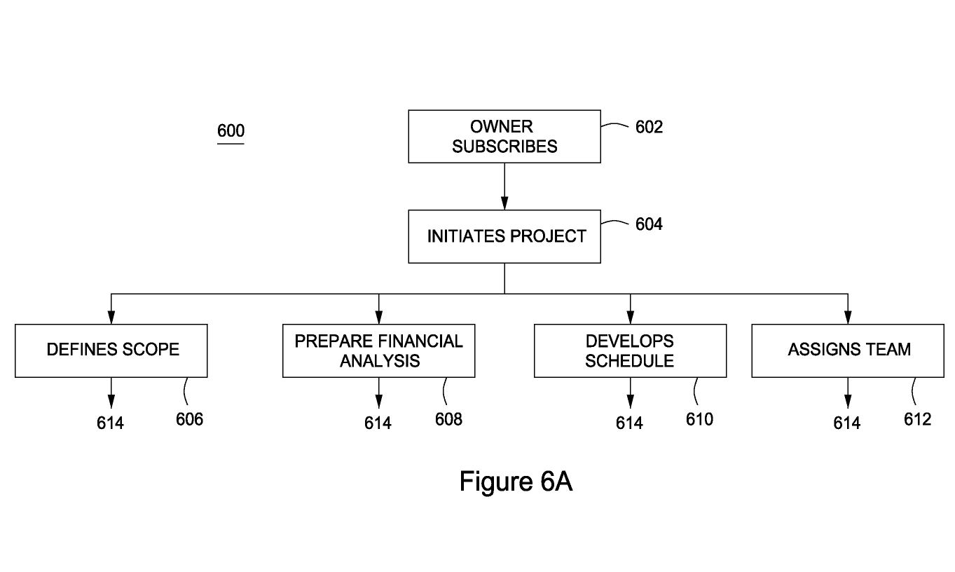

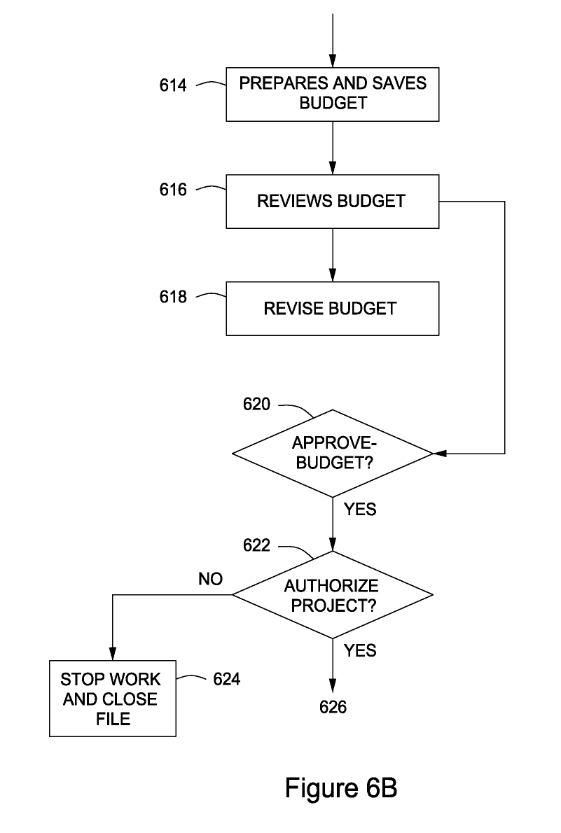

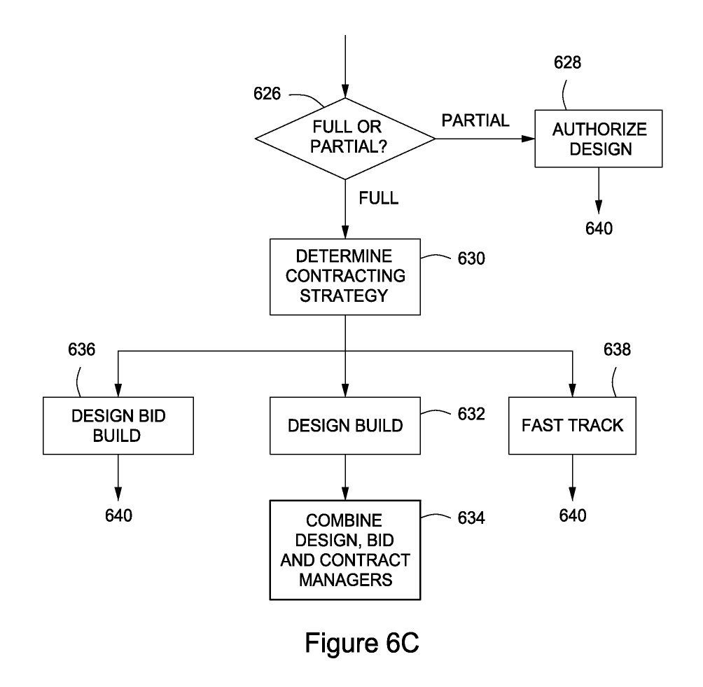

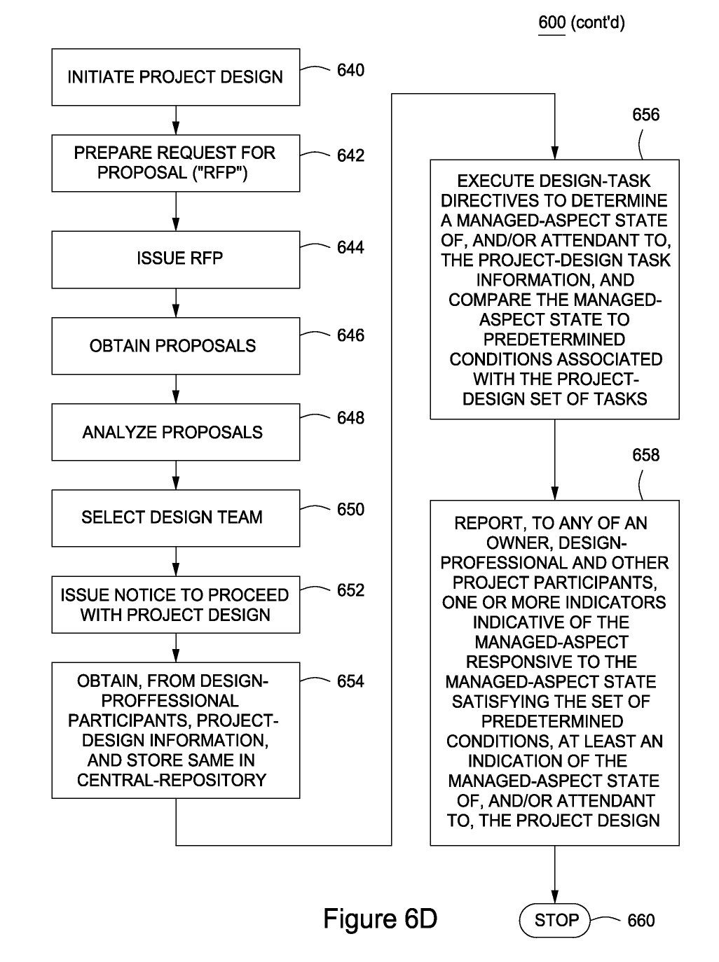

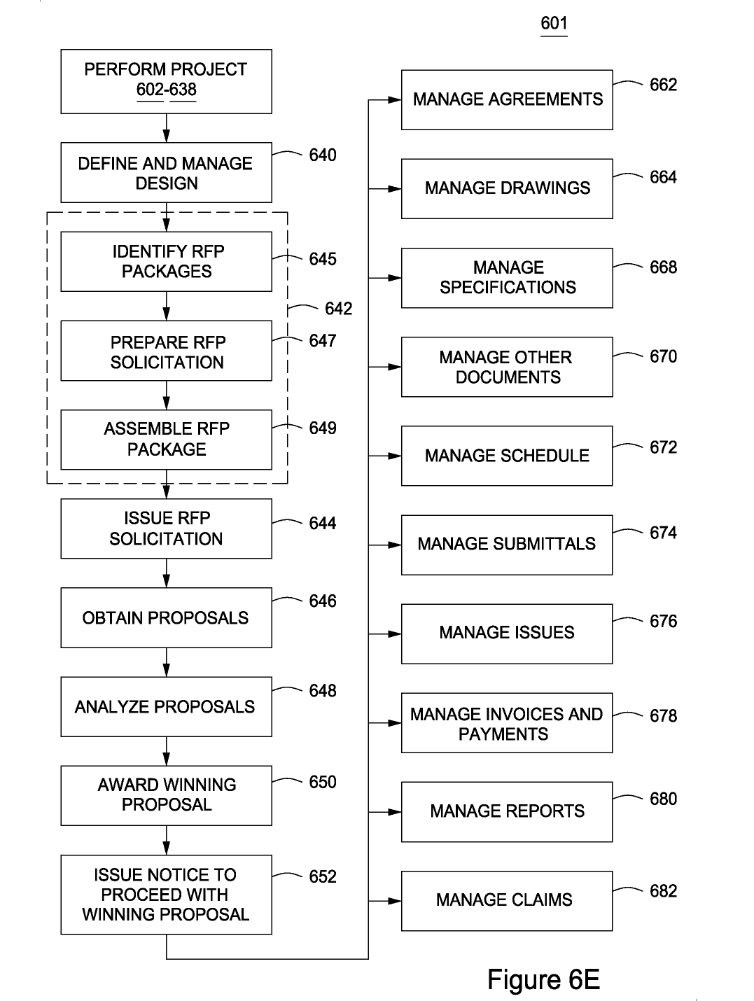

The flow 500 includes process blocks 502-510, and illustrates a general order of operations for performing project management of the C&D project. At the process block 502, a project definition phase of the C&D project is carried out in response to request from a project participant, who is an owner (“owner participant”) of the C&D project. Details of an example of the project definition phase are provided below with respect to FIGS. 6A-6B. The project definition phase of the C&D project may be carried out in different ways, as well. After the process block 502, the flow 500 may transition to one or more of alternative process blocks 504, 506, 508 and 510.

For example, the flow 500 may transition to process block 504 for performing activities associated with a design phase of the C&D project. Alternatively, the flow 500 may transition to process block 506 for performing activities associated with a construction phase of the C&D project, which generally occurs after the design phase is completed. Additionally and/or alternatively, the flow 500 may transition to process block 508 for performing activities associated with managing financials for the C&D project, which generally occurs any time after the project definition phase is completed. The flow 500 may transition to process block 510 for performing activities associated with managing common aspects of the C&D project, which generally occurs any time after the project definition phase is completed.

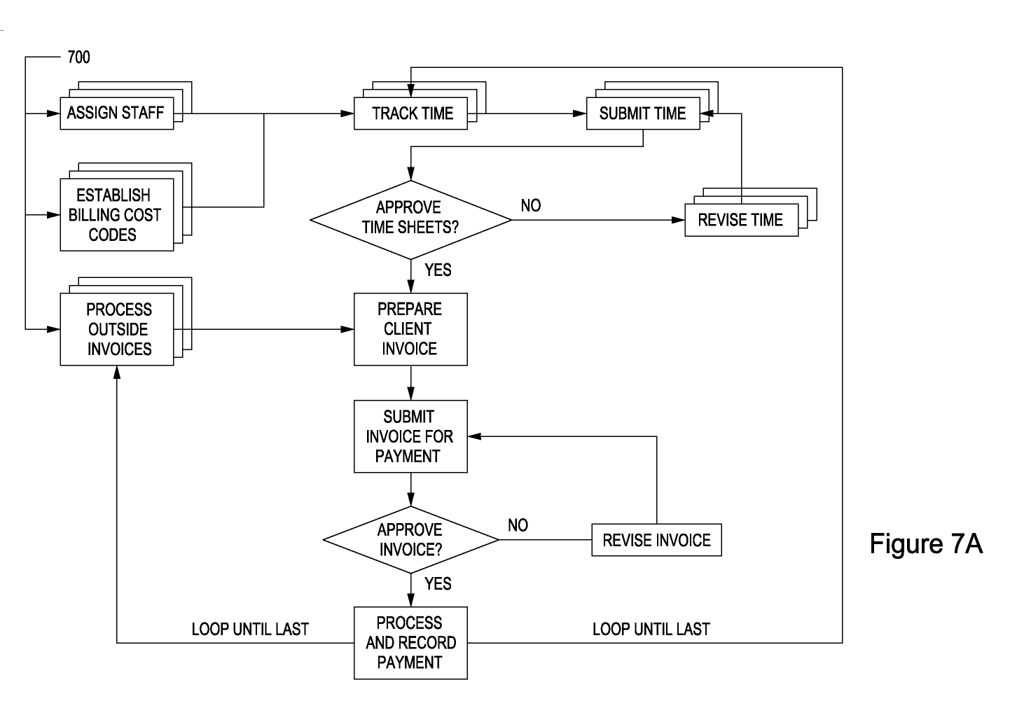

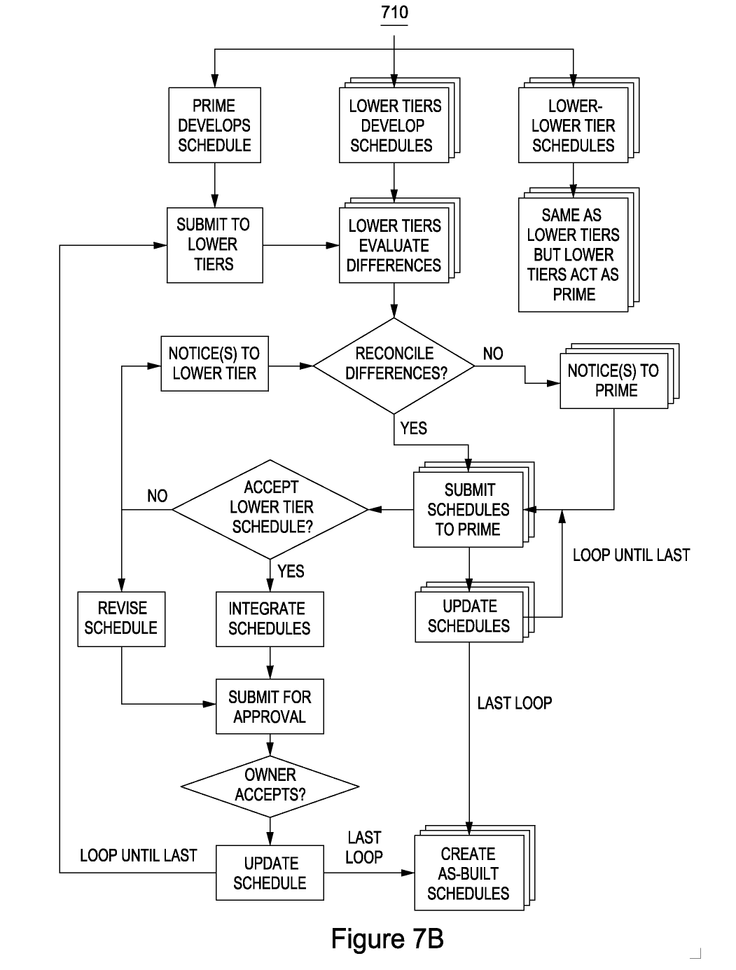

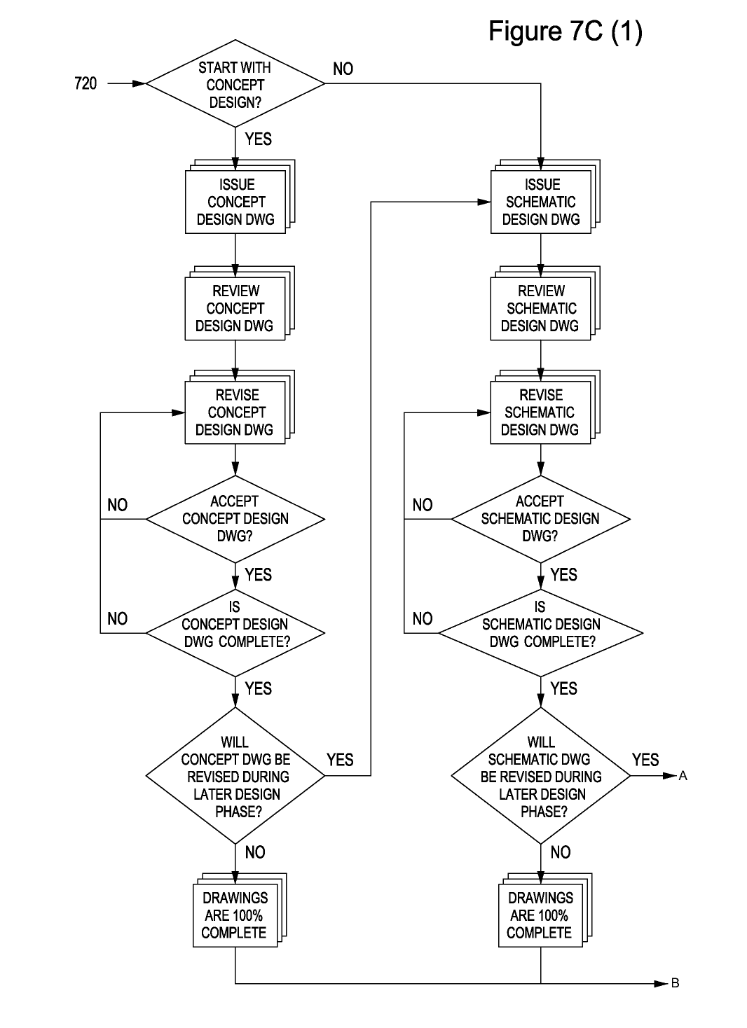

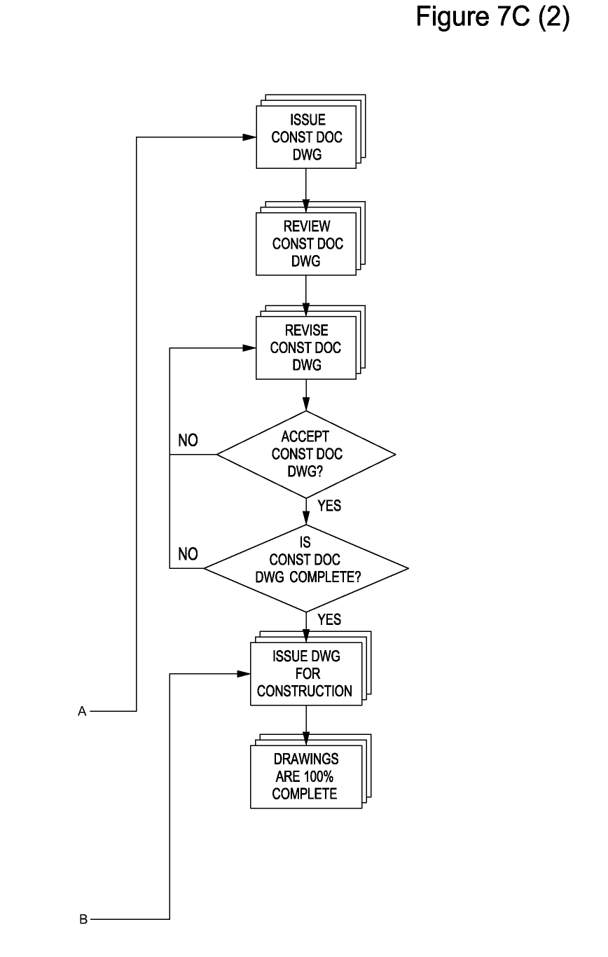

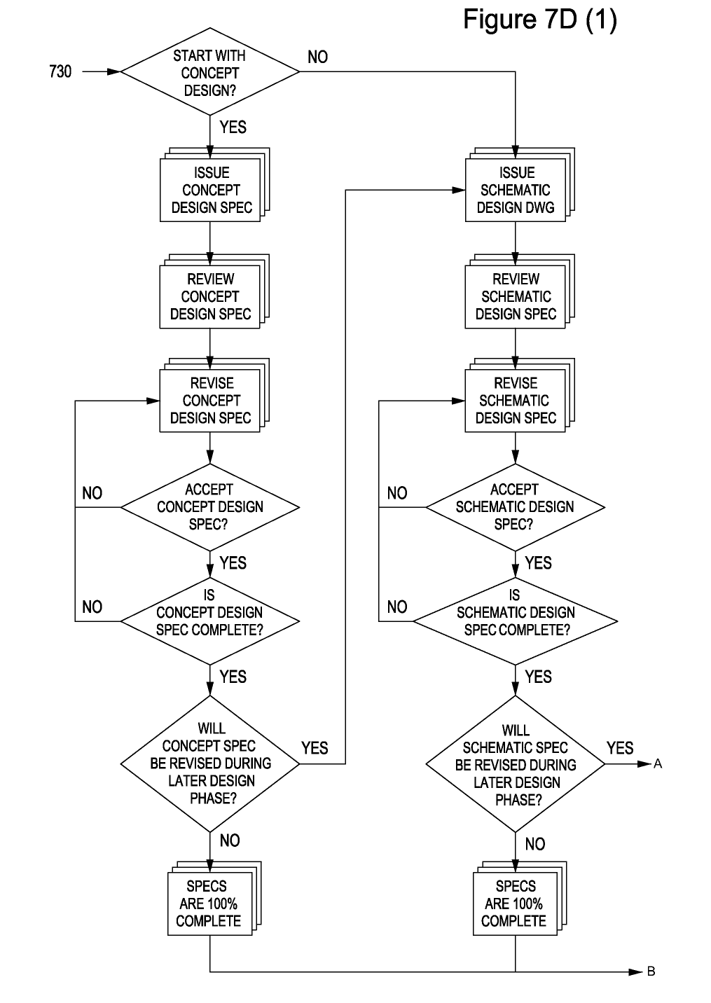

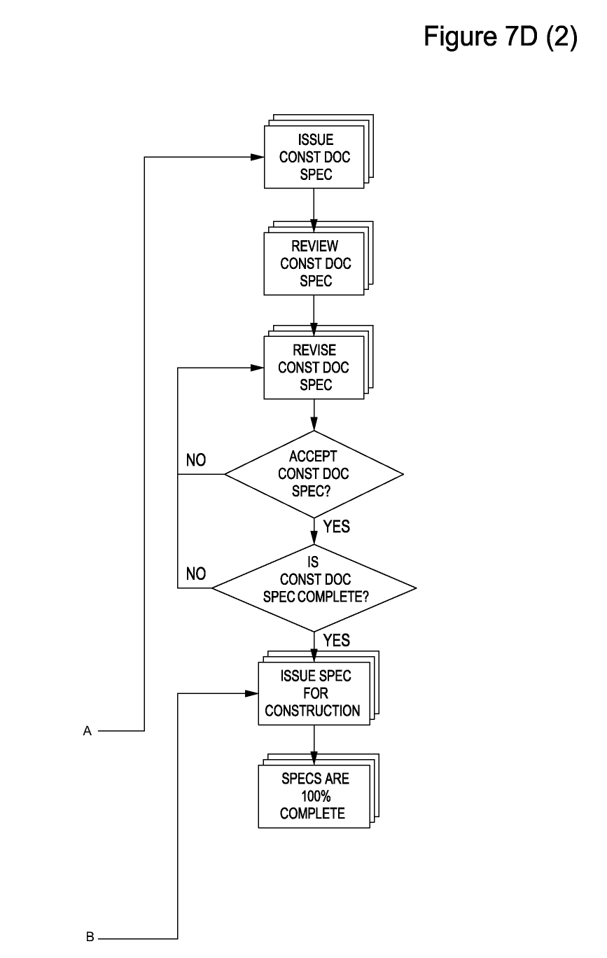

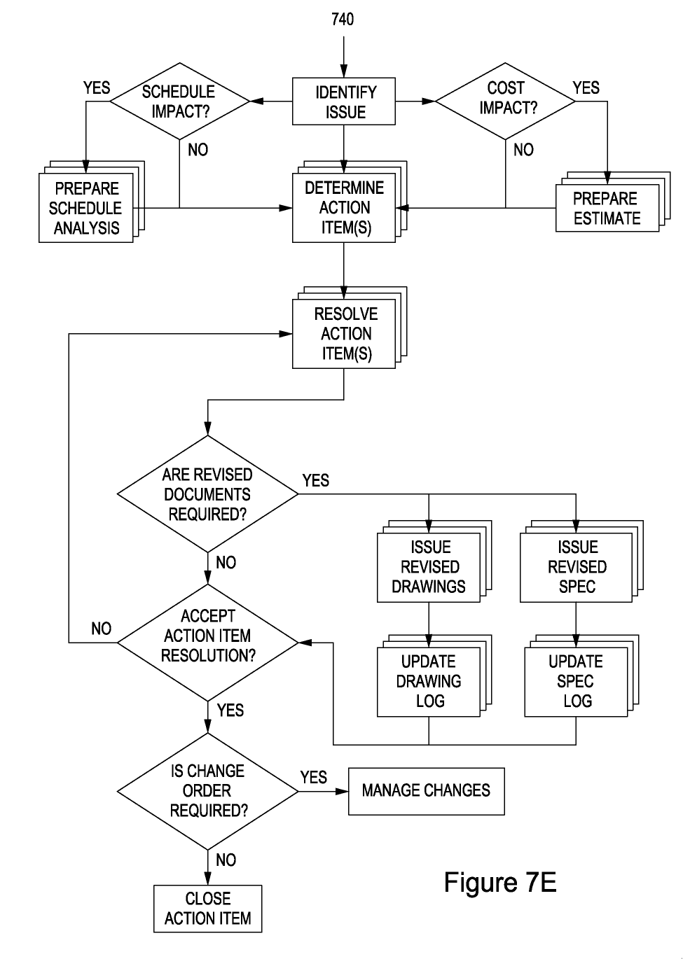

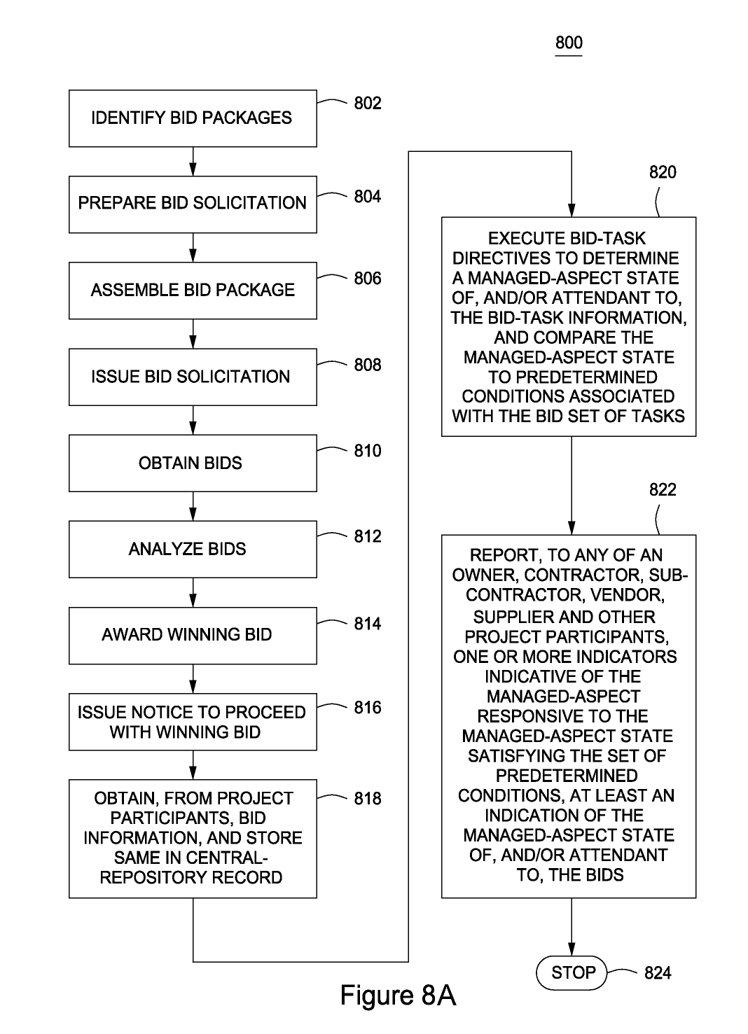

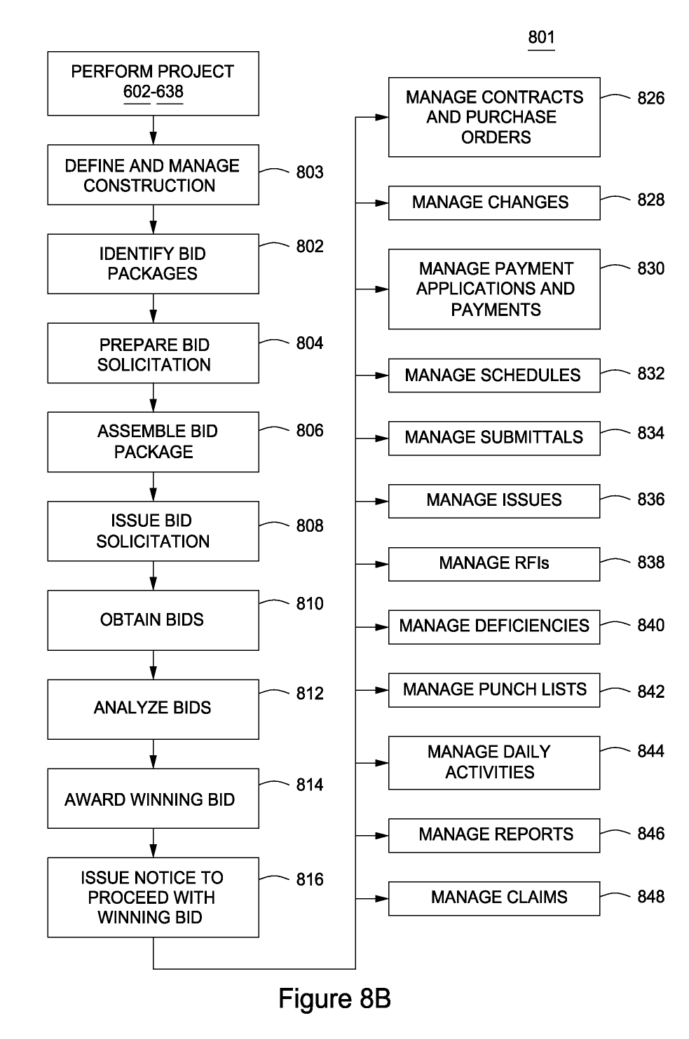

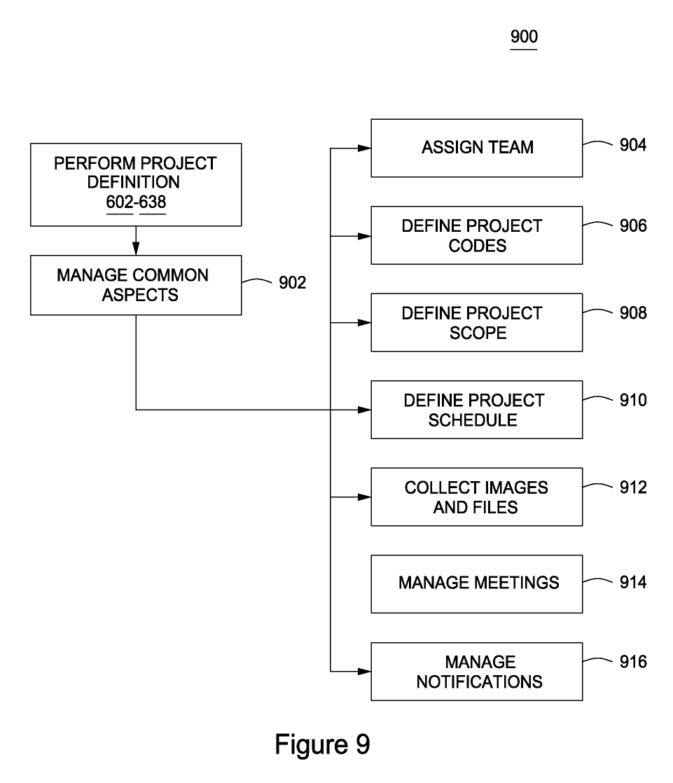

Details of examples for performing activities associated with the design phase (process block 504) are provided below with respect to FIGS. 6C-6E and 7A-7D. The design phase of the C&D project may be carried out in different ways, as well. Details of examples for performing activities associated with the construction phase (process block 506) are provided below with respect to FIGS. 8A-8B. The construction phase of the C&D project may be carried out in different ways, as well. Details of examples for performing activities associated with managing financials (process block 508) are provided below with respect to FIGS. 6A-6E, 7A-7D, 8A-8B and 9. The managing of financials of the C&D project may be carried out in different ways, as well. Details of examples for managing common aspects of the C&D project (process block 510) are provided below with respect to FIG. 9. The managing common aspects of the C&D project may be carried out in different ways, as well.

Referring now to FIGS. 6A-6D, a flow diagram illustrating a flow 600 for performing project management of, and/or attendant to, one or more of the C&D projects is shown. For convenience, the flow 600 is described with reference to the system 100 of FIGS. 1 and 3-4. The flow 600, however, may be carried out using other architectures as well.

Referring now to FIG. 6A, the flow 600 is initiated by the host 108. After being initiated, the host 108 executes its web server to enable the user devices 102₁-102ₙ , to render the project-management website via their respective web browsers, including the website widgets noted herein below. At some time after the host 108 executes its web server, the flow 600 may transition to process block 602.

At the process block 602, the host 108 may receive (e.g., responsive to selection of a subscription widget) a subscription request from a project participant, who is an owner (“owner participant”) of the C&D project. After the host 108 receives the subscription request, the host 108 may process the subscription request. Thereafter, the host 108 may request and receive, via the website entry and/or other electronic messaging, information about the owner participant and other project participants (collectively “project-participant information”).

The host 108 may also add the owner participant as a subscriber, and store the project-participant information in the central-repository record 114. After storing the project-participant information, the flow 600 may transition to process block 604.

At the process block 604, the host 108 may receive from the owner participant, responsive to selection of, e.g., a project-initiation widget, a request for an initiation of the C&D project (“project-initiation request”). After the host 108 receives the project-initiation request, the host 108 may initiate the C&D project, which may cause execution of the project-management framework 110, and in turn, configuration of the host 108 to manage the managed-aspects of, and/or attendant to, the C&D project or portion thereof. After the host 108 completes the project initiation process, the flow 600 may transition to one or more of alternative process blocks 606, 608, 610 and 612.

At the alternative process blocks 606, 608, 610 and/or 612, the host 108 may receive from the owner participant, responsive to selections of, e.g., scope-definition, financial-analysis, scheduling and/or team-assignment widgets, task information in the form of a scope definition, a prepared financial analysis, a schedule and a team assignment, respectively. The host 108 may then store this task information in the central-repository record 114. After one or more of the processes of the alternative process blocks 606, 608, 610 and/or 612 are performed, the flow 600 may transition to process block 614.

At the process block 614 (FIG. 6B), the host 108 may receive from the owner participant, responsive to selection of, e.g., a budget-preparation-and-saving widget, task information in the form of budget information. The host 108 may then store the budget information in the central-repository record 114. After one or more of the processes of the process block 614 are performed, the flow 600 may transition to process block 616.

At the process block 616, the host 108 may, responsive to selection of a budget-review widget, extract the budget information from the central-repository record 114, generate a prepared budget from the budget information extracted from the central-repository record 114, and send the prepared budget to the user device 102 for display to the owner participant. After one or more of the processes of the process block 616 are performed, the flow 600 may transition to decision block 618.

At decision block 618, the host 108 may receive from the owner participant, responsive to selection of, e.g., a budget-revision widget, a request to revise the prepared budget (“prepared-budget-revision request”). Responsive to this prepared-budget-revision request, the flow 600 may return to the process block 614, whereupon the host 108 may obtain and store in the central-repository record 114 additional task information in the form of additional budget information.

In the alternative, the host 108 might not receive prepared-budget-revision request, at the decision block 618. If, at the decision block 618, the host 108 does not receive the prepared-budget-revision request, then the flow 600 may transition to decision block 620.

At the decision block 620, the host 108 may receive from the owner participant, responsive to selection of, e.g., a budget-approval widget, an indication to approve the prepared budget (“prepared-budget-approval indication”). Responsively, the host 108 may incorporate and store the prepared-budget-revision indication, in the central-repository record 114, along with the other task information stored therein. After one or more of the decisions of the decision block 620 are carried out, the flow 600 may transition to decision block 622.

At the process block 622, the host 108 may receive from the owner participant, responsive to selection of, e.g., a project-authorization widget, an indication to authorize the C&D project (“project-authorization indication”). Responsively, the host 108 may incorporate and store the project-authorization indication, in the central-repository record 114, along with the other task information stored therein.

After one or more of the decisions of the decision block 622 are carried out, the flow 600 may transition to decision block 626 (FIG. 6C). In the alternative, the host 108 might not receive the project-authorization indication, at the decision block 622. If, at the decision block 622, the host 108 does not receive the project-authorization indication, then the flow 600 may transition to termination block 624.

At the termination block 624, the flow 600 may end, thereby causing the host 108 to stop additional management of the managed-aspects of the C&D project, and integrate and store, in the central-repository record 114 with the other task information, an indication that the C&D project is closed. Alternatively, the flow 600 may return to one or more of the aforementioned process blocks of FIGS. 6A-6B.

At the decision block 626 (FIG. 6C), the host 108 may receive from the owner participant, responsive to selection of, e.g., a design-authorization widget, an indication to authorize a design of the project in full (“design-authorization indication”). Responsively, the host 108 may incorporate and store the design-authorization indication, in the central-repository record 114, along with the other task information stored therein.

After one or more decisions of the decision block 626 are carried, the flow 600 may transition to process block 630. In the alternative, the host 108 might not receive the design-authorization indication, at the decision block 622. If, at the decision block 622, the host 108 does not receive the design-authorization indication, the flow 600 may transition to process block 628.

At the process block 628, the host 108 may receive from the owner participant, responsive to selection of, e.g., the design-authorization widget, an indication to authorize a partial design of the C&D project (“partial-design-authorization indication”). Responsively, the host 108 may incorporate and store the partial-design-authorization indication, in the central-repository record 114ₙ, along with the other task information stored therein. Thereafter, the flow 600 may transition to process block 640 (FIG. 6D).

At the process block 630 (FIG. 6C), the host 108 may receive from the owner participant, responsive to selection of, e.g., a contract-strategy widget, a request to apply a given contracting strategy of the project (“contract-strategy request”). Responsive to contract-strategy request, the host 108 may execute the contracting-strategy manager, and in turn, populate the central-repository record 114 with the predetermined conditions associated with the given contracting strategy, and deploy the directives associated with the given contracting strategy (“contracting-strategy directives”). After one or more of the processes of the process block 630 are performed, the flow 600 may transition to any of alternative process blocks 632, 636 and 638.

At the process block 632, the host 108 may receive from the owner participant, responsive to selection of, e.g., a design-and-build-manager widget, a request to apply given design and build tasks for the project (“design-and-build request”). Responsive to design-and-build request, the host 108 may execute the design and build managers. In turn, the host 108 may populate the central-repository record 114 with the predetermined conditions associated with the design and build sets of tasks, deploy directives associated with the design set of tasks (“design-task directives”), and deploy directives associated with the build set of tasks (“build-task directives”). After one or more of the processes of the process block 632 are performed, the flow 600 may transition to process block 634.

At the process block 634, the host 108 may combine the design, build and contract managers to enable the host 108 to monitor and/or track the managed-aspect states. After the process block 634, the flow 600 may terminate. Alternatively, the flow 600 may transition to process block 636.

At the process block 636, the host 108 may receive from the owner participant, responsive to selection of, e.g., a design-bid-build-manager widget, a request to apply given design, bid and build tasks for the project (“design-bid-and-build request”). Responsive to design-bid-and-build request, the host 108 may execute the design, bid and build managers. In turn, the host 108 may populate the central-repository record 114 with the predetermined conditions associated with each of the design, bid and build sets of tasks. The host 108 may also deploy the design-task directives, the build-task directives, and directives associated with the bid set of tasks (“bid-task directives”).

After one or more of the processes of the process block 636 are performed, the flow 600 may transition to process block 640 (FIG. 6D). Alternatively, the flow 600 may transition to process block 638. At the process block 638, the host 108 may receive from the owner participant, responsive to selection of, e.g., a fast-track widget, a request to place the project on a fast track. In response, the host 108 may escalate the project to a higher status than other projects. After one or more of the processes of the process block 638, the flow 600 may transition to the process block 640 (FIG. 6D).

At the process block 640 (FIG. 6D), the host 108 may receive from the owner participant, responsive to selection of, e.g., an initiate-design widget, a request to initiate the project design (“initiate-project-design request”). Responsive to the initiate-project-design request, the host 108 may receive the task information for the project-design tasks from the project participant, via the user device 102. Thereafter, the host 108 may populate the central-repository record 114 with the task information for the project-design tasks. After one or more of the processes of the process block 640 are performed, the flow 600 may transition to process block 642.

At the process block 642, the host 108 may receive from the owner participant, responsive to selection of, e.g., an RFP-preparation widget, a request to initiate a wizard for preparing an RFP online (“online-RFP-preparation-wizard request”). Responsive to the online-RFP-preparation-wizard request, the host 108 may initiate the online-RFP wizard, and in turn, receive from the owner participant task information in the form of information for preparing any of a prequalification document, a scheduling form and a fee form associated with the project design. Some of the information for preparing any of the prequalification document, scheduling form and fee form may be pre-populated using task information, such as budget information, extracted from the central-repository record 114. After one or more of the processes of the process block 642 are performed, the flow 600 may transition to process block 644.

At the process block 644, the host 108 may issue the RFP for the project design to project participants, who are design professionals (“design-professional participants”) and have been accepted by the host 108 as subscribers. After the process block 644, the flow 600 may transition to process block 646.

At the process block 646, the host 108 may receive from one or more of the design-professional participants, responsive to selections of, e.g., respective instances of the RFP-submission widget, task information in the form of information for completing each of a set of proposals. This task information may include information for completing any of the prequalification document, scheduling form and fee form of each of the set of proposals. The host 108 may also accept or receive, from the design-professional participants, updates and/or revisions to the information for completing each of the set of proposals. The host 108 may do so up until a closing due date and/or time specified by the RFP, at which point the host 108 may mark such information for completing each of the proposals as read only. The host 108 may also integrate or otherwise combine, and then store, the information for completing each of the proposals (and updates and/or revision thereto) in the central-repository record 114 along with the other task information. After one or more of the processes of the process block 646 are performed, the flow 600 may transition to process block 648. Information entered by design professionals might not be available to owner participant until after bid closing date and time.

At the process block 648, the host 108 may perform an analysis of the set of proposals. The host 108 may perform the analysis using an algorithm for determining the most cost effective proposal from the set of proposals. After one or more of the processes of the process block 648 are performed, the flow 600 may transition to process block 650.

At the process block 650, the host 108 may receive from the owner participant, responsive to selection of, e.g., a design-team-selection widget, an indication of the design team awarded the project design (“design-team indication”). The host 108 may integrate or otherwise combine, and then store, the design-team indication, in the central-repository record 114, along with the other task information. After one or more of the processes of the process block 650 are performed, the flow 600 may transition to process block 652.

At the process block 652, the host 108 may receive a notice to proceed with the project design from the design-professional participant and/or owner participant (contractee). The host 108 may receive the notice in response to selection of, e.g., a project agreement widget or in response to an electronic message or alert sent by the host 108. The host 108 may issue the notice to proceed responsive to the host 108 applying directives to the task information, and determining that the design-professional participant and owner participant executed an agreement, whereby the design-professional participant is obligated to handle the project design. After one or more of the processes of the process block 652 are performed, the flow 600 may transition to process block 654.

At the process block 654, the host 108 may obtain the task information associated with the set of project-design tasks (“project-design-task information”). This task information may include budget information, scheduling information, drawing lists, specification lists, etc. The host 108 may extract portions of the project-design-task information, e.g., the budget and scheduling information from the task information stored in the central-repository record 114. Additionally and/or alternatively, the host 108 may receive, from the design-professional participant, other portions of the project-design-task information, e.g., drawing and specification lists; and/or supplements to the extracted portions of the project-design-task information. The host 108 may also integrate or otherwise combine, and then store, the received portions of the project-design-task information and/or supplements to the extracted portions of the project-design-task information in the central-repository record 114. After one or more of the processes of the process block 654 are performed, the flow 600 may transition to process block 656.

At the process block 656, the host 108 may execute (i) the design-task directives to determine the managed-aspect state of, and/or attendant to, the project design, and (ii) compare the managed-aspect state to the set of predetermined conditions associated with the design set of tasks. For example, the host 108 may apply the design-task directives to determine the managed-aspect state of, and/or attendant to, any of the budget, schedules, drawing lists, specification lists and the like, and compare the managed states of, and/or attendant to, the budget, schedules, drawing lists, specification lists and the like to the set of predetermined conditions associated with the project-design set of tasks. This way, the host 108 may track actual costs against budgets, actual schedule against planned schedule and issues; and/or create drawings and specifications from the drawing and specification lists, respectively. After one or more of the processes of the process block 656, the flow 600 may transition to process block 658.

At the process block 658, the host 108 may report to any of the owner, design-professional and other project participants, one or more of the state indicators indicative of the managed-aspect state of, and/or attendant to, the C&D project design. The host 108 may report such state indicators in response to the managed-aspect state satisfying one or more of the set of predetermined conditions associated with the project-design set of tasks. The report may be any of an electronic message and/or alert sent to the owner, design-professional and other project participants, where the electronic message and/or alert may include the state indicators indicative of the managed-aspect state. After receipt, the owner, design-professional and other project participants may display the state indicators via their user devices 102₁-102ₙ.

After one or more of the processes of the process block 658 are performed, the flow 600 may transition to termination block 660, whereupon the flow 600 may terminate. Alternatively, the flow 600 may be repeated periodically, in continuous fashion, or upon being triggered as a result of a condition, such as a change in date or in task information. As another alternative, any of the aforementioned process blocks may be repeated periodically, in continuous fashion, or upon being triggered as a result of a condition, such as a change in date or in task information.

FIG. 6E is a flow diagram illustrating an example flow 601 for performing project management of, and/or attendant to, one or more of the C&D projects. For convenience, the flow 601 is described with reference to the system 100 of FIGS. 1 and the system 300 of FIGS. 3-4. The flow 601, however, may be carried out using other architectures as well. The flow 601 of FIG. 6E is similar to the flow 600 of FIGS. 6A-6D, except as described herein below. In addition including the process blocks 602-652 of the flow 600 (FIGS. 6A-6D), the flow 601 may include process blocks 662, 670, 672, 674, 676, 678, 680 and 682.

After performing one or more of the functions of the process block 652 (flow 600 of FIGS. 6A-6D), the flow 601 may transition to any of the process blocks 662, 664, 668, 670, 672, 674, 676, 678, 680 and 682, in no particular order. Assume, for example, the flow 601 transitions to the process block 662. At the process block 662, the host 108 may manage the design aspects of, and/or attendant to, the agreements associated with the project design (“design-agreement aspects”). To facilitate managing these design-agreement aspects, the host 108, as configured by design agreement sub-module 3082, may extract portions of the project-design-task information associated with the design agreements from the task information stored in the central-repository record 114.

The host 108 may also execute (i) the design-task directives to determine the managed-aspect states of, and/or attendant to, the design-agreement aspects (“design-agreement-aspects states”), and (ii) compare the design-agreement-aspects states to the set of project-design pre-conditions. Thereafter, the host 108 may report to any of the owner, design-professional and other project participants, one or more of the state indicators indicative of the design-agreement-aspects states of, and/or attendant to, the C&D project design. The host 108 may report such state indicators in response to the design-agreement-aspects states satisfying one or more of the set of project-design pre-conditions. The report may be any of an electronic message and/or alert sent to the owner, design-professional and other project participants, where the electronic message and/or alert may include the state indicators indicative of the design-agreement-aspects states. After receipt, the owner, design-professional and other project participants may display the state indicators via their user devices 102₁-102ₙ.

After one or more of the processes of the process block 662 are performed, the flow 601 may transition to any of the process blocks 664, 668, 670, 672, 674, 676, 678, 680 and 682, in no particular order. Assume, for example, the flow 601 transitions to the process block 664. At process block 664, the host 108 may manage the design aspects of, and/or attendant to, the drawings associated with the project design (“design-drawing aspects”). To facilitate managing these design-drawing aspects, the host 108, as configured by design drawing sub-module 3083, may extract portions of the project-design-task information associated with the design drawings from the task information stored in the central-repository record 114.

The host 108 may also execute (i) the design-task directives to determine the managed-aspect states of, and/or attendant to, the design-drawing aspects (“design-drawing-aspects states”), and (ii) compare the design-drawing-aspects states to the set of project-design pre-conditions. Thereafter, the host 108 may report to any of the owner, design-professional and other project participants, one or more of the state indicators indicative of the design-drawing-aspects states of, and/or attendant to, the C&D project design. The host 108 may report such state indicators in response to the design-drawing-aspects states satisfying one or more of the set of project-design pre-conditions. The report may be any of an electronic message and/or alert sent to the owner, design-professional and other project participants, where the electronic message and/or alert may include the state indicators indicative of the design-drawing-aspects states. After receipt, the owner, design-professional and other project participants may display the state indicators via their user devices 102₁-102ₙ.

After one or more of the processes of the process block 664 are performed, the flow 601 may transition to any of the process blocks 662, 668, 670, 672, 674, 676, 678, 680 and 682, in no particular order. Assume, for example, the flow 601 transitions to the process block 668. At the process block 668, the host 108 may manage the design aspects of, and/or attendant to, the specifications associated with the project design (“design-specification aspects”). The host 108 may manage the design-specification aspects in substantially the same or similar way as above with respect to managing the design-drawing aspects.

After one or more of the processes of the process block 668 are performed, the flow 601 may transition to any of the process blocks 662, 664, 670, 672, 674, 676, 678, 680 and 682, in no particular order. Upon transitioning to any of the process blocks 670, 672, 674, 676, 678, 680 and 682, the host 108 may manage the design aspects of, and/or attendant to, the miscellaneous design documents, design schedule, design submittals, design issues, design invoices and payments, reports and claims, respectively. The host 108 may manage the design aspects of, and/or attendant to, each of the miscellaneous design documents, design schedule, design submittals, design issues, design invoices and payments, reports and claims in substantially the same or similar way as above with respect to managing the design-drawing aspects.

After the any of the process blocks 662, 664, 668, 670, 672, 674, 676, 678, 680 and 682, the flow 601 may terminate. Alternatively, the flow 601 may be repeated periodically, in continuous fashion, or upon being triggered as a result of a condition, such as a change in date or in task information. As another alternative, any of the aforementioned process blocks may be repeated periodically, in continuous fashion, or upon being triggered as a result of a condition, such as a change in date or in task information.

FIGS. 7A-7E are flow diagrams illustrating a plurality of flows for performing project management of, and/or attendant to, portions of a C&D project. For example, the host 108 may carry out flow 700 (FIG. 7A), in accordance with the principles of the flow 200, to manage the managed aspects of, and/or attendant to, billing and invoicing of payments for professional fees of the design-professional participants. The host 108 may also carry out flow 710 (FIG. 7B), in accordance with the principles of the flow 200, to manage the managed aspects of, and/or attendant to, scheduling of the C&D project design.

Alternatively and/or additionally, the host 108 may carry out flow 720 (FIG. 7C), in accordance with the principles of the flow 200, to manage the managed aspects of, and/or attendant to, drawings for the C&D project. As another alternative, the host 108 may carry out flow 730 (FIG. 7D), in accordance with the principles of the flow 200, to manage the managed aspects of, and/or attendant to, specifications for the C&D project. The host 108 may further carry out flow 740 (FIG. 7E), in accordance with the principles of the flow 200, so as to manage the managed aspects of, and/or attendant to, issues arising during a phase of the project design.

Referring now to FIG. 8A, a flow diagram illustrating example flow 800 for performing project management of, and/or attendant to, one or more of the C&D projects is shown. For convenience, the flow 800 is described with reference to the system 100 of FIGS. 1 and the system 300 of FIGS. 3-4. The flow 800, however, may be carried out using other architectures as well.

Like the flow 600, the flow 800 may be initiated by the host 108. After being initiated, the host 108 executes its web server to enable the user devices 102₁-102ₙ to render the project-management website via respective web browsers, including the website widgets noted herein below. At some time after the host 108 executes its web server, the flow 800 may transition to process block 802.

At the process block 802, the host 108 may receive from the owner, contractor or other participant, responsive to selection of, e.g., an identify-bid-packages widget, a request to identify bid packages for the C&D project (“identify-bid-package request”). Responsive to the identify-bid-package request, the host 108 may receive task information for the set of bid tasks, via the user device 102. Thereafter, the host 108 may populate the central-repository record 114 with the bid-task information. After one or more of the processes of the process block 802 are performed, the flow 800 may transition to process block 804.

At the process block 804, the host 108 may receive from the owner, contractor or other participant, responsive to selection of, e.g., a bid-preparation widget, a request to initiate a wizard for preparing bid packages online (“online-bid-preparation-wizard request”). Responsive to the online-bid-preparation-wizard request, the host 108 may initiate the online-bid wizard, and in turn, receive from the owner, contractor or other participant task information in the form of information for preparing any of budget, scheduling and other bid forms associated with the C&D project. Some of the information for preparing any of the budget, scheduling and other bid forms may be pre-populated using task information, such as budget and scheduling information, extracted from the central-repository record 114. After one or more of the processes of the process block 804 are performed, the flow 800 may transition to process block 806.

At the process block 806, the host 108 assembles the bid packages using the bid information extracted from the central-repository record 114. After the bid packages are assembled, the flow 800 may transition to process block 808.

At the process block 808, the host 108 the host 108 may solicit bids from any of the project participants (“bid participants”), including contractors, subcontractors, owners, vendor and suppliers. After one or more of the processes of the process block 808 are performed, the flow 800 may transition to process block 810.

At the process block 810, the host 108 may receive from one or more of the bid participants, responsive to selections of, e.g., respective instances of a bid-submission widget, task information in the form of information for completing each of a set of bids. This task information may include information for completing any of the budget, scheduling and other bid forms associated with the C&D project. The host 108 may also accept or receive, from the bid participants, updates and/or revisions to the information for completing each of the set of bids. The host 108 may do so up until a closing due date and/or time specified by the bid solicitation, at which point the host 108 may mark such information for completing each of the bids as read only. The host 108 may also integrate or otherwise combine, and then store, the information for completing each of the bids (and updates and/or revision thereto) in the central-repository record 114 along with the other task information. After one or more of the processes of the process block 810 are performed, the flow 800 may transition to process block 812.

At the process block 812, the host 108 may perform an analysis of the set of bids. The host 108 may perform the analysis using an algorithm for determining the most cost effective bid from the set of bids. After one or more of the processes of the process block 812 are performed, the flow 800 may transition to process block 814.

At the process block 814, the host 108 may receive from the owner participant, responsive to selection of, e.g., a bid-winner widget, an indication of the bidder participant awarded the bid (“winning-bid indication”). The host 108 may integrate or otherwise combine, and then store, the winning-bid indication, in the central-repository record 114, along with the other task information. After one or more of the processes of the process block 814 are performed, the flow 800 may transition to process block 816.

At the process block 816, the host 108 may receive a notice to proceed with the winning bid from the bid participant and/or owner participant. The host 108 may receive the notice in response to selection of, e.g., a bid agreement widget or in response to an electronic message or alert sent by the host 108. The host 108 may issue the notice to proceed responsive to the host 108 applying directives to the task information, and determining that the bid participant and owner participant executed an agreement, whereby the bid participant is obligated to handle the portion of the C&D project bid on. After one or more of the processes of the process block 816 are performed, the flow 800 may transition to process block 818.

At the process block 818, the host 108 may obtain the task information associated with the set of bid tasks (“bid-task information”). This task information may include budget information, scheduling information, estimates for payment, etc. The host 108 may extract portions of the bid-task information, e.g., the budget and scheduling information from the task information stored in the central-repository record 114. Additionally and/or alternatively, the host 108 may receive, from the bid participant, other portions of the bid-task information, e.g., estimates for payment; and/or supplements to the extracted portions of the bid-task information. The host 108 may also integrate or otherwise combine, and then store, the received portions of the bid-task information and/or supplements to the extracted portions of the bid-task information in the central-repository record 114. After one or more of the processes of the process block 818 are performed, the flow 800 may transition to process block 820.

At the process block 820, the host 108 may execute (i) the bid-task directives to determine the managed-aspect state of, and/or attendant to, the bid-on portion of the C&D project, and (ii) compare the managed-aspect state to the set of predetermined conditions associated with the set of bid tasks. For example, the host 108 may apply the bid-task directives to determine the managed-aspect state of, and/or attendant to, any of the budget, schedules, estimates for payment and the like, and compare the managed states of, and/or attendant to, the budget, schedules, estimates for payment and the like to the set of predetermined conditions associated with the set of bid tasks. This way, the host 108 may track actual costs against budgets, actual schedule against planned schedule and actual payments against estimated payments. After one or more of the processes of the process block 820, the flow 800 may transition to process block 822.

At the process block 822, the host 108 may report to any of the owner, bid and other project participants, one or more of the state indicators indicative of the managed-aspect state of, and/or attendant to, the bid-on portion of the C&D project. The host 108 may report such state indicators in response to the managed-aspect state satisfying one or more of the set of predetermined conditions associated with the set of bid tasks. The report may be any of an electronic message and/or alert sent to the owner, bid and other project participants, where the electronic message and/or alert may include the state indicators indicative of the managed-aspect state. After receipt, the owner, bid and other project participants may display the state indicators via their user devices 102₁-102ₙ.

After one or more of the processes of the process block 822 are performed, the flow 800 may transition to termination block 824, whereupon the flow 800 may terminate. Alternatively, the flow 800 may be repeated periodically, in continuous fashion, or upon being triggered as a result of a condition, such as a change in date or in task information. As another alternative, any of the aforementioned process blocks may be repeated periodically, in continuous fashion, or upon being triggered as a result of a condition, such as a change in date or in task information.

FIG. 8B is a flow diagram illustrating an example flow 801 for performing project management of, and/or attendant to, one or more of the C&D projects. For convenience, the flow 801 is described with reference to the system 100 of FIGS. 1 and the system 300 of FIGS. 3-4. The flow 801, however, may be carried out using other architectures as well. The flow 801 of FIG. 8B is similar to the flow 800 of FIG. 8A, except as described herein below. In addition including the process blocks 602-638 of the flow 600 (FIGS. 6A-6D) and the process blocks 802-816, the flow 601 may include process blocks 826, 828, 830, 832, 834, 836, 838, 840, 842, 844, 846 and 848.

After performing one or more of the functions of the process block 816 (flow 800 of FIG. 8A), the flow 801 may transition to any of the process blocks 826, 828, 830, 832, 834, 836, 838, 840, 842, 844, 846 and 848, in no particular order. Assume, for example, the flow 601 transitions to the process block 826. At the process block 826, the host 108 may manage the managed aspects (“construction aspects”) of, and/or attendant to, the contracts and/or purchase orders associated with the construction phase of the project (“construction-contract-PO aspects”). To facilitate managing the construction-contract-PO aspects, the host 108, as configured by construction module 312, may extract, from the task information stored in the central-repository record 114, portions of the construction-task information associated with the contracts and/or purchase orders.

The host 108 may also execute (i) the construction-task directives to determine the managed-aspect states of, and/or attendant to, the construction-contract-PO aspects (“construction-contract-PO states”), and (ii) compare the construction-contract-PO states to the set of construction pre-conditions. Thereafter, the host 108 may report to any of the owner, contractors, subcontractors and other project participants, one or more of the state indicators indicative of the construction-contract-PO states of, and/or attendant to, the C&D project. The host 108 may report such state indicators in response to the construction-contract-PO states satisfying one or more of the set of construction pre-conditions. The report may be any of an electronic message and/or alert sent to the owner, contractor, subcontractor and other project participants, where the electronic message and/or alert may include the state indicators indicative of the construction-contract-PO states. After receipt, the owner, contractor, subcontractor and other project participants may display the state indicators via their user devices 102₁-102ₙ.

After one or more of the processes of the process block 826 are performed, the flow 801 may transition to any of the process blocks 828, 830, 832, 834, 836, 838, 840, 842, 844, 846 and 848, in no particular order. Assume, for example, the flow 601 transitions to the process block 828. At the process block 828, the host 108 may manage the construction aspects of, and/or attendant to, the changes, payment applications and payments, schedules, submittals, issues, RFIs, deficiencies, punch lists, daily activities, reports and claims, respectively, associated with the construction of the C&D project. The host 108 may manage the construction aspects of, and/or attendant to, each of the changes, payment applications and payments, schedules, submittals, issues, RFIs, deficiencies, punch lists, daily activities, reports and claims associated with the construction of the C&D project in substantially the same or similar way as above with respect to managing the construction-contract-PO aspects.

After any of the process blocks 826, 828, 830, 832, 834, 836, 838, 840, 842, 844, 846 and 848, the flow 801 may terminate. Alternatively, the flow 801 may be repeated periodically, in continuous fashion, or upon being triggered as a result of a condition, such as a change in date or in task information. As another alternative, any of the aforementioned process blocks may be repeated periodically, in continuous fashion, or upon being triggered as a result of a condition, such as a change in date or in task information.

Referring now to FIG. 9, a flow diagram illustrating an example flow 900 for performing project management of, and/or attendant to, one or more of the C&D projects is shown. For convenience, the flow 900 is described with reference to the system 100 of FIGS. 1 and the system 300 of FIGS. 3-4. The flow 900, however, may be carried out using other architectures as well. The flow 900 of FIG. 9 is similar to the flow 601 of FIG. 6E, except as described herein below.

After performing one or more of the functions of the process blocks 602-638 (flow 601 of FIG. 6E), the flow 900 may transition to process block 902, whereupon the host 108 may initiate managing the managed aspects of, and/or attendant to, portions of the project that common to or among more than one phase of the project (“common aspects”). To facilitate managing the common aspects, the host 108 may perform some or all of process blocks 904, 906, 908, 910, 912, 914 and 916, in no particular order. For each of the process blocks 904, 906, 908, 910, 912, 914 and 916, the host 108 may extract, from the task information stored in the central-repository record 114, portions of the common-task information. This common-task information may include (i) information for assigning project team participants (process block 904), (ii) project codes (process block 906), (iii) project scope information (process block 908), (iv) project schedule (process block 910), (v) collection information of images and files (process block 912), (vi) information for managing meetings (process block 914) and (vii) information for managing reports and/or notifications (process block 916).

For each of the process blocks 904, 906, 908, 910, 912, 914 and 916, the host 108 may also execute (i) the construction-task directives to determine the managed-aspect states of, and/or attendant to, the common aspects (“common-aspect states”), and (ii) compare the common-aspect states to the set of common-aspect pre-conditions. Thereafter, the host 108 may report to any of the applicable project participants, one or more of the state indicators indicative of the common-aspect states of, and/or attendant to, the C&D project. The host 108 may report such state indicators in response to the common-aspect states satisfying one or more of the set of common aspect pre-conditions. The report may be any of an electronic message and/or alert sent to the appropriate project participants, where the electronic message and/or alert may include the state indicators indicative of the common-aspect states. After receipt, the project participants may display the state indicators via their user devices 102₁-102ₙ.

After the any of the process blocks 904, 906, 908, 910, 912, 914 and 916, the flow 900 may terminate. Alternatively, the flow 900 may be repeated periodically, in continuous fashion, or upon being triggered as a result of a condition, such as a change in date or in task information. As another alternative, any of the aforementioned process blocks may be repeated periodically, in continuous fashion, or upon being triggered as a result of a condition, such as a change in date or in task information.

Example Host Architecture

Referring to now to FIG. 4A, a block diagram illustrating example architecture of the host 108 is shown. As understood by embodiments of the present disclosure, components shown in dashed outline may be optional. Components of host 108 may include, a processor 220, a system memory 230, a memory/graphics interface 221, also known as a Northbridge chip, and an I/O interface 222, also known as a Southbridge chip. The system memory 230 and a graphics processor 290 may be coupled to the memory/graphics interface 221. A monitor 291 or other graphic output device may be coupled to the graphics processor 290.

A series of system busses may couple various system components including a high speed system bus 223 between the processor 220, the memory/graphics interface 221 and the I/O interface 222, a front-side bus 224 between the memory/graphics interface 221 and the system memory 230, and an advanced graphics processing (AGP) bus 225 between the memory/graphics interface 221 and the graphics processor 290. The system bus 223 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hypertransport architecture, respectively.

The host 108 typically includes a variety of computer readable media. Computer readable media can be any available media that can be accessed by host 108 and includes both volatile and nonvolatile media, removable and non-removable media. By way of example, and not limitation, computer readable media may include computer readable storage media and communication media. Computer storage media include volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and can accessed by the host 108. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable storage media.

The system memory 230 may include computer readable storage media in the form of volatile and/or nonvolatile memory such as read only memory (ROM) 231 and random access memory (RAM) 232. The system ROM 231 may include permanent system data 243, such as identifying and manufacturing information. In accordance with some embodiments, a basic input/output system (BIOS) may also be stored in system ROM 231. RAM 232 typically contains data and/or program modules that are immediately accessible to and/or presently being operated on by processor 220. By way of example, and not limitation, the host 108 may include operating system 234; application programs 235; other program modules 236, such as the project-management platform 110; and program data 237. It is contemplated within embodiments of the present disclosure that any embodiment of the present disclosure may be implemented via an application program 235 or other program modules 237 and may utilize program data 237.

The I/O interface 222 may couple the system bus 223 with a number of other buses 226, 227 and 228 that couple a variety of internal and external devices to the host 108. A serial peripheral interface (SPI) bus 226 may connect to a BIOS memory 233 containing the basic routines that help to transfer information between elements within host 108, such as during start-up. In accordance with some embodiments of the present disclosure, a security module 229 may be incorporated to manage metering, billing, and enforcement of policies.

A super input/output chip 260 may be used to connect to a number of ‘legacy’ peripherals, such as floppy disk 252, keyboard/mouse 262, and printer 296, as examples. The super I/O chip 260 may be connected to the I/O interface 222 with a low pin count (LPC) bus, in accordance with some embodiments. The super I/O chip 260 is widely available in the commercial marketplace.

In one embodiment, bus 228 may be a Peripheral Component Interconnect (PCI) bus, or a variation thereof, may be used to connect higher speed peripherals to the I/O interface 222. A PCI bus may also be known as a Mezzanine bus. Variations of the PCI bus include the Peripheral Component Interconnect-Express (PCI-E) and the Peripheral Component Interconnect-Extended (PCI-X) busses, the former having a serial interface and the latter being a backward compatible parallel interface. In other embodiments, bus 228 may be an advanced technology attachment (ATA) bus, in the form of a serial ATA bus (SATA) or parallel ATA (PATA).

The host 108 may also include other removable/non-removable, volatile/nonvolatile computer storage media. By way of example only, the host 108 may include memory 240 that may read from or writes to non-removable, nonvolatile magnetic media or, alternatively, may read from or write to removable and/or volatile media. Removable media, such as a universal serial bus (USB) memory 252 or CD/DVD drive 256 may be connected to the PCI bus 228 directly or through an interface 250. Other removable/non-removable, volatile/nonvolatile computer readable storage media that can be used in the exemplary operating environment include, but are not limited to, magnetic tape cassettes, flash memory cards, digital versatile disks, digital video tape, solid state RAM, solid state ROM, or the like.

The drives and their associated computer storage media, discussed above and illustrated in FIG. 4A, provide storage of computer readable instructions, data structures, program modules and other data for the host 108, including, for example, the central repository 112, and the central-repository records 114₁₋ₙ. Hard disk drive 240 is illustrated as storing operating system 244, application programs 245, other program modules 246, and program data 247. Note that these components can either be the same as or different from operating system 234, application programs 235, other program modules 236, and program data 237. Operating system 244, application programs 245, other program modules 246, and program data 247 are given different numbers here to illustrate that, at a minimum, they are different elements within the host 108. A user may enter commands and information into the host 108 through input devices such as a mouse/keyboard 262 or other input device combination. Other input devices (not shown) may include a microphone, joystick, game pad, satellite dish, scanner, or the like. These and other input devices are often connected to the processor 220 through one of the I/O interface busses, such as the SPI 226, the LPC 227, or the PCI 228, but other busses may be used. In accordance with some embodiments, other devices may be coupled to parallel ports, infrared interfaces, game ports, or the like (not depicted), via the super I/O chip 260.

The host 108 may operate in a networked environment using logical connections to one or more remote computers, such as a remote computer 280 via a network interface controller (NIC) 270. The remote computer 280 may be a personal computer, a server, a router, a network PC, a peer device or other common network node, and typically includes many or all of the elements described above relative to the host 108. The logical connection between the NIC 270 and the remote computer 280 depicted in FIG. 4A may include a local area network (LAN), an Ethernet-based network, a wide area network (WAN), or both, but may also include other networks. Such networking environments are commonplace in offices, enterprise-wide computer networks, intranets, and the Internet.

It is appreciated by embodiments of the present disclosure, in FIG. 4A, that both transmitter 110 and receiver 120, may utilize certain of the features of the host 108 of FIG. 1, whereas many of such features or elements are incorporated in most communication devices presently in existence.

Example User Device Architecture

Referring now to FIG. 4B, a block diagram illustrating example architecture of the user device 102 is shown. As above, the user device 102 may be any of a personal computer; a portable computer, a handheld computer; a mobile phone, a digital assistant, a personal digital assistant, a cellular phone, a smart phone, a pager, a digital tablet, a laptop computer, an Internet appliance and the like. In general, the user device 102 includes a processor-based platform that operates on any suitable operating system, such as Apple® Mac OS X Lion® and iOS 4.2®, Android®, Microsoft® Windows®, Linux and/or Symbian; and that is capable of executing software.

The user device 102 may, however, include a large number of elements; many of which are not shown in FIG. 4B for simplicity of exposition. The user device 102 may be formed in a single unitary device and concentrated on a single node; serving, client, peer or otherwise. Alternatively, the user device 102 may be formed from one or more separate devices, and as such, may be distributed among a number of nodes; serving, client, peer or otherwise. In addition, the user device 102 may be scaleable (i.e., may employ scale-up and/or scale-out approaches).

As shown, the user device 102 may include a processing platform 312 that is operable to control, manipulate or otherwise interact with monitor 314 and/or an I/O device 316, via respective couplings. The processing platform 312 includes one or more processing units (collectively “processor”) 310, memory 313, supports circuits and a bus. The processor 310 may be one or more conventional processors, microprocessors, multi-core processors and/or microcontrollers. The support circuits facilitate operation of the processor 310 and may include well-known circuitry or circuits, including, for example, an I/O interface; one or more network-interface units (“NIUs”); cache; clock circuits; power supplies; and the like.

The processor 310 may use the NIUs for exchanging the project data and workflow content the host via the network. Accordingly, the NIUs may be adapted for communicating over any of the terrestrial wireless, satellite, and/or wireline media. The memory 313 may store (and receive requests from the processor 310 to obtain) software 318, the records and various other stored software packages, such as an operating system and modules 330₁₋ₙ and module options 332₁₋ₙ. The memory 313 may be or employ random access memory, read-only memory, optical storage, magnetic storage, removable storage, erasable programmable read only memory and variations thereof, content addressable memory and variations thereof, flash memory, disk drive storage, removable storage, any combination thereof, and the like. In addition, the memory 313 may store (and receive requests from the processor 310 to obtain) operands, operators, dimensional values, configurations, and other data that are used by the operating system and the software 318 to control the operation of and/or to facilitate performing the functions of the user device 102.

The bus provides for transmissions of digital information among the processor 310, the memory 313, support circuits and other portions of the user device 102 (shown and not shown). The I/O interface is adapted to control transmissions of digital information between (shown and not shown) components of the user device 102. In addition, the I/O interface is adapted to control transmissions of digital information between I/O devices disposed within, associated with or otherwise attached to the user device 102. Examples of the I/O devices include the I/O device 316, the monitor 314 and any or any combination of (i) storage devices, including but not limited to, a tape drive, a floppy drive, a hard disk drive or a compact disk drive, (ii) a receiver, (ii) a transmitter, (iii) a speaker, (iv) a display, (v) a speech synthesizer, (vi) an output port, and (vii) the like.

The operating system may include code for operating the user device 102 and for providing a platform onto which the software 318 can be executed. The software 318 may include the GUI software and other user-device software 318 or modules, which as described in more detail above, may carry out the exchange of the content using communication and security protocols compatible with the user device 102 and host 108.

The GUI software and user-device software 318 may be in any of a standalone, client/server, peer-to-peer and other format. The GUI software may include, in a standalone or peer-to-peer format, code for accessing services offered by the host 108. Through this code, the GUI software is operable to substantiate its identity, and in turn, receive authorization to obtain the services offered by the host 108.

The monitor 314 may be any suitable device that displays viewable images generated by the processing platform 312. For instance, the monitor 314 may be any of or any combination of a liquid-crystal-display based monitor, a cathode ray tube monitor, a plasma display monitor, a surface-conduction electron-emitter display monitor, an organic light-emitting diode display monitor, or any other monitor that can display viewable images using television and/or computer protocols, such as Super Video Graphics Array, Digital Visual Interface, Phase Alternating Line, SECAM, NTSC, etc.

The I/O device 316 may be any device that accepts input from a user (man or machine) to control, manipulate or otherwise interact with the operation of the processing platform 312. Examples of the I/O device 316 include any of or any combination of pointing device, such as a mouse, joystick, trackball, touchpad, pointing stick, light pen, head pointer, soap mouse, eye tracking devices, digitizing tablet and stylus, data glove that translates the user's movements to computer gestures; and a key-in device, such as a keyboard or a touchpad. Although shown as one device, the I/O device 316 may be separated into two or more devices; each of which may have, as compared to the I/O device 316, reduced, increased or equivalent functionality.

The processing platform 312 includes memory 308 that is capable of storing (i) software, such as graphical-user-interface (“GUI”) software; and (ii) one or more records 332, each of which may be stored as or in a single file or a plurality of files. The records 332 may be structured as text, a table, a database, a document formed using a markup or markup-like language, such as eXtensible Markup Language (“XML”), eXtensible Markup Language—Remote Procedure Calling protocol (“XML/RPC”), Hypertext Transfer Protocol (“HTTP”), Simple Object Access Protocol (“SOAP”), and the like. The modules 3301, and module options 3321, may generally be similar to those described herein above.

The processor 310 may be capable of executing the GUI software, executing the modules 3301, and executing the module options 3321,, storing records in the memory 308, dispatching records, issuing triggers and/or issuing commands. The GUI software, when executed by the processor 310, may execute a GUI and render on the monitor 314 at least one display screen 336 of the GUI.

While the foregoing is directed to embodiments of the present disclosure, other and further embodiments of the invention may be devised without departing from the basic scope thereof. It is understood that various embodiments described herein may be utilized in combination with any other embodiment described, without departing from the scope contained herein. Further, the foregoing description is not intended to be exhaustive or to limit the invention to the precise form disclosed. Modifications and variations are possible in light of the above teachings or may be acquired from practice of the invention.

No element, act, or instruction used in the description of the present application should be construed as critical or essential to the invention unless explicitly described as such. Also, as used herein, the article “a” is intended to include one or more items. Where only one item is intended, the term “one” or similar language is used. Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Further, as used herein, the term “set” is intended to include any number of items, including zero. Further, as used herein, the term “number” is intended to include any number, including zero.

Moreover, the claims should not be read as limited to the described order or elements unless stated to that effect. In addition, use of the term “means” in any claim is intended to invoke 35 U.S.C. §112, ¶6, and any claim without the word “means” is not so intended.

What is claimed is:

1. A system for performing project management of or attendant to, or of and attendant to, at least one project, wherein the at least one project comprises a set of tasks, wherein the system comprises a server having a framework, which when executed by the server, configures the server to manage at least one aspect of or attendant to, or of and attendant to, any of the at least one project and portion thereof, and wherein configuring the server to manage at least one aspect comprises configuring the server to:
obtain, from at least one user of a set of users, information associated with the set of tasks;
apply at least one directive of the framework to the information to determine a state of or attendant to, or of and attendant to, the at least one aspect;
compare the state to a set of predetermined conditions; and
report, responsive to the state satisfying the set of predetermined conditions, at least an indication of the state of or attendant to, or of and attendant to, the at least one aspect.

2. The system of claim 1, wherein the at least one aspect comprises any of a scope, cost and schedule of or attendant to, or of and attendant to, any of the at least one project and portion thereof.

3. The system of claim 1, wherein the at least one project comprises at least one project for any of a construction and a design.

4. The system of claim 1, wherein the indication comprises an indication of a status of or attendant to, or of and attendant to, at least one of the set of tasks, and wherein configuring the server to report at least an indication of the state comprises configuring the server to:
send, to at least one user of the set of users, an electronic message having an indicator indicative of the status,
display the indicator to at least one user of the set of users via an electronic display; or
send the electronic message to at least one user of the set of users, and display the indicator to at least one user of the set of users on the electronic display.

5. The system of claim 1, wherein the state of or attendant to, or of and attendant to, the at least one aspect comprises a first state, wherein the indication of the state comprises a first indication, and wherein configuring the server further comprises configuring the server to:
apply the at least one directive of the framework to the information to determine a second state of or attendant to, or of and attendant to, the at least one aspect;
compare the second state to a second set of predetermined conditions; and
report, responsive to the second state satisfying the second set of predetermined conditions, at least a second indication of the second state of or attendant to, or of and attendant to, the at least one aspect.

6. The system of claim 5, wherein the first and second indications comprise respective indications of statuses of or attendant to, or of and attendant to, at least one of the set of tasks, and wherein configuring the server to report at least first and second indications of first and second states, respectively, comprises configuring the server to:
send, to at least one user of the set of users, at a first time, a first electronic message having a first indicator indicative of the first status,
display the first indicator to at least one user of the set of users on an electronic display at the first time;
send the electronic message to at least one user of the set of users at the first time, and display the first indicator to at least one user of the set of users on an electronic display at the first time;
send, to at least one user of the set of users, at a second time, a second electronic message having a second indicator indicative of the second status,
display the second indicator to at least one user of the set users on an electronic display at the second time; or
send the second electronic message to at least one user of the set of users at the second time, and display the second indicator to at least one user of the set of users on an electronic display at the second time.

7. The system of claim 1, wherein the information associated with the set of tasks comprises information associated with a set of activities performed by at least one user of the set of users with respect to the set of tasks.

8. The system of claim 2, wherein the framework comprises a project module, and wherein the project module is adapted to configure the server to:
define, in accordance with the information associated with the set of tasks, any of a scope, cost and schedule of or attendant to, or of and attendant to, any of the at least one project and portion thereof;
apply at least one directive of the framework to the information to determine a state of or attendant to, or of and attendant to, any of the scope, cost and schedule;
compare the state to a set of predetermined conditions associated with the scope, cost and schedule, as appropriate; and
report, responsive to the state satisfying the set of predetermined conditions, at least an indication of the state of or attendant to, or of and attendant to, any of the scope, cost and schedule.

9. The system of claim 1, wherein the framework comprises a financials module, wherein the set of users comprises at least one user having access to the financial module, and wherein the financials module is adapted to configure the server to:
obtain the information associated with a set of tasks from the at least one user having access to the financial module;
define, in accordance with the information obtained from the at least one user having access to the financial module, any of budget and financial information of or attendant to, or of and attendant to, any of the at least one project and portion thereof;
apply at least one directive of the framework to the information to determine a state of or attendant to, or of and attendant to, any of the budget and financial information;
compare the state to a set of predetermined conditions associated with the budget and financial information, as appropriate; and
report, responsive to the state satisfying the set of predetermined conditions, at least an indication of the state of or attendant to, or of and attendant to, any of the budget and financial information.

10. The system of claim 1, wherein the framework comprises a request-for-proposal (RFP) module, wherein the set of users comprises at least one user having access to the RFP module, and wherein the RFP module is adapted to configure the server to:
obtain the information associated with a set of tasks from the at least one user having access to the RFP module, wherein the information comprises information associated with a request for proposal;
apply at least one directive of the framework to the information to determine a state of or attendant to, or of and attendant to, any of the information associated with the request for proposal;
compare the state to a set of predetermined conditions associated with the information associated with the request for proposal, as appropriate; and
report, responsive to the state satisfying the set of predetermined conditions, at least an indication of the state of or attendant to, or of and attendant to, any of the information associated with the request for proposal.

11. The system of claim 1, wherein the framework comprises a design module, wherein the set of users comprises at least one user having access to the design module, and wherein the design module is adapted to configure the server to:
obtain the information associated with a set of tasks from the at least one user having access to the design module;
define, in accordance with the information obtained from the at least one user having access to the design module, any of design work, design schedule, design budget and design fees of or attendant to, or of and attendant to, any of the at least one project and portion thereof;
apply at least one directive of the framework to the information to determine a state of or attendant to, or of and attendant to, any of the design work, design schedule, design budget and design fees;
compare the state to a set of predetermined conditions associated with the design work, design schedule, design budget and design fees, as appropriate; and
report, responsive to the state satisfying the set of predetermined conditions, at least an indication of the state of or attendant to, or of and attendant to, any of the design work, design schedule, design budget and design fees.

12. The system of claim 1, wherein the framework comprises a bid module, wherein the set of users comprises at least one user having access to the bid module, and wherein the bid module is adapted to configure the server to:
obtain the information associated with a set of tasks from the at least one user having access to the bid module, wherein the information comprises information associated with at least one bid;
apply at least one directive of the framework to the information to determine a state of or attendant to, or of and attendant to, any of the information associated with the at least one bid;
compare the state to a set of predetermined conditions associated with the information associated with the at least one bid, as appropriate; and
report, responsive to the state satisfying the set of predetermined conditions, at least an indication of the state of or attendant to, or of and attendant to, any of the information associated with the at least one bid.

13. The system of claim 1, wherein the framework comprises a construction module, wherein the set of users comprises at least one user having access to the construction module, and wherein the construction module is adapted to configure the server to:
obtain the information associated with a set of tasks from the at least one user having access to the construction module;
define, in accordance with the information obtained from the at least one user having access to the construction module, contract information of or attendant to, or of and attendant to, any of the at least one project and portion thereof;
apply at least one directive of the framework to the information to determine a state of or attendant to, or of and attendant to, any of the contract information;
compare the state to a set of predetermined conditions associated with the contract information, as appropriate; and
report, responsive to the state satisfying the set of predetermined conditions, at least an indication of the state of or attendant to, or of and attendant to, any of the contract information.

14. The system of claim 1, wherein the framework comprises a reports module, and wherein the reports module is adapted to configure the server to: report, responsive to the state satisfying the set of predetermined conditions, any of the indication of the state and a report containing information associated with the set of tasks.

15. The system of claim 14, wherein the framework comprises a notifications module, and wherein the notifications module is adapted to configure the server to:
generate the indication of the state of or attendant to, or of and attendant to, the at least one aspect;
maintain at list of outstanding notifications associated with any indication so generated; and
notify, the at least one user of the set of users of the indication of state, in accordance with the list of outstanding notifications.

16. The system of claim 1, wherein the framework comprises a claims module, wherein the set of users comprises at least one user having access to the claims module, and wherein the claims module is adapted to configure the server to:
obtain the information associated with a set of tasks from the at least one user having access to the construction module;
define, in accordance with the information obtained from the at least one user having access to the construction module, claims information of or attendant to, or of and attendant to, any of the at least one project and portion thereof;
apply at least one directive of the framework to the information to determine a state of or attendant to, or of and attendant to, any of the claims information;
compare the state to a set of predetermined conditions associated with the claims information, as appropriate; and
report, responsive to the state satisfying the set of predetermined conditions, at least an indication of the state of or attendant to, or of and attendant to, any of the claims information.

17. The system of claim 1, wherein the framework comprises any of a project module, financials module, request-for-proposal module, design module, bid module, construction module, reports module, notifications module and claims module.

18. The system of claim 17, wherein configuring the server to obtain information associated with the set of tasks comprises configuring the server to:
obtain the information, from the at least one user of a set of users, via any of the project module, financials module, request-for-proposal module, design module, bid module, construction module, reports module, notifications module and claims module; and
make available to at least one other user of the set of users at least a portion of the information obtained, from the at least one user of the set of users, via any of the project module, financials module, request-for-proposal module, design module, bid module, construction module, reports module, notifications module and claims module.

19. The system of claim 1, wherein the framework comprises a project module, wherein the set of users comprises a first group of users and a second set of users, wherein each of the first group of users has a first level of authorization, wherein each of the second group of users has a first level of authorization, and wherein the project module is adapted to configure the server to:
segregate, based on the first and second levels of authorization, the information associated with the tasks into at least first and second groups of information, respectively;
make the first and second groups of information available to the first group of users; and
make the second group of information available to the second group of users.

20. A method for performing project management of or attendant to, or of and attendant to, at least one project, wherein the at least one project comprises a set of tasks, the method comprising:
managing, responsive to an execution of a framework adapted therefore, at least one aspect of or attendant to, or of and attendant to, any of the at least one project and portion thereof, wherein managing at least one aspect comprises:
obtaining, from at least one user of a set of users, information associated with the set of tasks;
applying at least one directive of the framework to the information to determine a state of or attendant to, or of and attendant to, the at least one aspect;
comparing the state to a set of predetermined conditions; and
reporting, responsive to the state satisfying the set of predetermined conditions, at least an indication of the state of or attendant to, or of and attendant to, the at least one aspect.

21. The method of claim 20, wherein the at least one aspect comprises any of a scope, cost and schedule of or attendant to, or of and attendant to, any of the at least one project and portion thereof.

22. The method of claim 20, wherein the at least one project comprises at least one project for any of a construction and a design.

23. The method of claim 20, wherein the information associated with the set of tasks comprises information associated with a set of activities performed by at least one user of the set of users with respect to the set of tasks.

24. The method of claim 20, wherein the framework comprises any of a project module, financials module, request-for-proposal module, design module, bid module, construction module, reports module, notifications module and claims module.

25. The method of claim 24, wherein obtaining information associated with the set of tasks comprises:
obtaining the information, from the at least one user of a set of users, via any of the project module, financials module, request-for-proposal module, design module, bid module, construction module, reports module, notifications module and claims module; and
making available to at least one other user of the set of users at least a portion of the information obtained, from the at least one user of the set of users, via any of the project module, financials module, request-for-proposal module, design module, bid module, construction module, reports module, notifications module and claims module.

26. The method of claim 20, wherein the framework comprises a project module, wherein the set of users comprises a first group of users and a second set of users, wherein each user of the first group of users has a first level of authorization, wherein each user of the second group of users has a second level of authorization, and wherein managing the at least one aspect comprises, responsive to execution of the project module:
segregating, based on the first and second levels of authorization, the information associated with the tasks into at least first and second groups of information, respectively;
making the first and second groups of information available to the first group of users; and
making the second group of information available to the second group of users.

27. A computer-readable-storage medium comprising computer-executable instructions for performing project management of or attendant to, or of and attendant to, at least one project, wherein the at least one project comprises a set of tasks, wherein the computer-executable instructions comprise a framework adapted to configure a computer to manage at least one aspect of or attendant to, or of and attendant to, any of the at least one project and portion thereof, and wherein configuring the computer to manage the at least one aspect comprises configuring the computer to:
obtain, from at least one user, information associated with the set of tasks;
apply at least one directive of the framework to the information to determine a state of or attendant to, or of and attendant to, the at least one aspect;
compare the state to a set of predetermined conditions; and
report, responsive to the state satisfying the set of predetermined conditions, at least an indication of the state of or attendant to, or of and attendant to, the at least one aspect.
